(19) United States
(12) Patent Application Publication
(10) Pub. No.: US 2024/0097242 A1
(43) Pub. Date: Mar. 21, 2024

(54) MOISTURE ELECTRIC GENERATOR BATTERY CELL

(71) Applicant: AUSTRALIAN ADVANCED MATERIALS PTY LTD, Subiaco (AU)

(72) Inventors: Dewei CHU, Killara (AU); Tao WAN, Kingsford (AU)

(21) Appl. No.: 18/274,437

(22) PCT Filed: Jan. 25, 2022
(86) PCT No.: PCT/AU2022/050036

§ 371 Date: Jul. 26, 2023

(30) Foreign Application Priority Data
Jan. 27, 2021 (AU) 2021900179
Jun. 30, 2021 (AU) 2021901986

(51) Int. Cl. H01M 14/00; C08J 3/215; C08K 3/04; H01M 4/62

(52) U.S. Cl. CPC H01M 14/00; C08J 3/215; C08K 3/042; H01M 4/622; H01M 4/625; C08J 2329/04

(57) ABSTRACT

A functional layer for a moisture electric generating battery cell wherein the functional layer includes graphene oxide having a ratio of C═O bonds to C—C bonds of more than 1:9. The functional layer include treated graphene oxide having an interlayer spacing that is greater than the interlayer spacing of graphene oxide from which the treated graphene oxide is prepared. The functional layer consists of graphene oxide and a polymer binder that is selected to bond with an electrically conductive substrate. The polymer binder may be one or more of: PVA, PVB, PMMA or PVP. The graphene oxide and polymer binder are treated with acid such as HCl, H₂SO₄ or HNO₃. The electrically conductive substrate forming an electrode may be mounted onto a further substrate, for use as a moist-electric generation (MEG) in an electronic device. The electronic device is configured to have a surface positioned in contact with the skin of a subject when in use.

This application claims priority from Australian provisional patent applications 2021901986 and 2021900179, which are incorporated herein by reference in their entirety.

### FIELD OF INVENTION

The present invention relates to a moisture electric generator battery cell and, in particular, to a moisture electric generator battery cell comprising at least one layer including a carbon containing material and a binder. More particularly, the carbon containing material comprises graphene-oxide (GO) and the binder comprises polyvinyl alcohol (PVA). Further, the invention relates to a functional layer for a moisture electric generating battery cell wherein the functional layer includes graphene oxide having a ratio of C═O bonds to C—C bonds of more than 1:9.

### BACKGROUND

Harvesting green energy from the environment plays a vital role in the development of future energy supply due to the shortage of traditional energy sources. Moisture, one of the most abundant green energy sources, remains to be utilised for energy harvesting and conversion from thermal energy to electricity. Recently, moisture-electric generators (MEGs) with ionised groups or polar bonds in the nanomaterials have been widely investigated to harvest energy from the moisture in the environment and convert it into electric power by the moisture absorption and ion migration. For example, the oxygen functional groups in the surface of carbon nanomaterials interact with water molecules from the moisture and dissociate the water molecule to generate the mobile hydrogen ions. Therefore, more hydrogen ions in the outer layer exposed to the moisture contribute to concentration difference of hydrogen ions for an electric potential. Moreover, MEGs have also been demonstrated to be used as wearable devices by harvesting moisture from respiration or environment, which presents a great potential in self-powered wearable devices.

Generally, metallic oxides (TiO₂) and carbon-based materials (graphene oxides, polymer) are employed for MEGs as polar bonds or oxygen-based groups (—OH and —COOH) can absorb H⁺ ions and induce potential. Specially, graphene oxides (GO) show high specific surface area, abundant oxygen-based groups, and good mechanical properties, which exhibits fast moisture absorption and steady electric output. Besides, GO can be modified with oxygen-based groups or inner structure to further improve its electric output. In a recent study, a flexible MEG based on graphene oxide presented an open-circuit voltage of 0.7 V with a small size of 0.8 mm². However, the voltage or current of MEG is strongly related to the relative humidity (RH) in the environment and shows instantaneous output, which inhibit its widespread application in electric generator. Besides, the electric output of MEG requires further improvement so that it is applicable for powering devices with high power. The mechanism of electric generation and enhancement should also be investigated to better understand its fabrication and application for powering devices in the future.

### SUMMARY OF THE INVENTION

In one aspect the invention provides, a functional layer for a moisture electric generating battery cell wherein the functional layer includes graphene oxide having a ratio of C═O bonds to C—C bonds of more than 1:9. The ratio of C═O bonds to C—C bonds may be more than 1:8 or more than 1:7 or more than 1:6 or more than 1:5.

The ratio of C═O bonds to C—C bonds may be less than 1:1.

C═O is a double bond between an oxygen atom and a carbon atom. C—C is a single bond between a carbon atom and another carbon atom.

The functional layer consists of graphene oxide and a polymer binder that is selected to bond with an electrically conductive substrate. The polymer binder may be one or more of: PVA, PVB, PMMA or PVP. The electrically conductive substrate forming an electrode may be mounted onto a further substrate.

In embodiments the graphene oxide and the polymer binder are a generally homogenous mixture with the graphene oxide and the polymer binder in the range of 100:1 to 2:1.

In embodiments the functional layer includes treated graphene oxide having an interlayer spacing that is greater than the interlayer spacing of graphene oxide from which the treated graphene oxide is prepared.

In embodiments the treated graphene oxide has a ratio of C═O bonds to C—C bonds of more than 1:9. The ratio of C═O bonds to C—C bonds may be more than 1:8 or more than 1:7 or more than 1:6 or more than 1:5. The ratio of C═O bonds to C—C bonds may be less than 1:1.

In embodiments the interlayer spacing of the treated graphene oxide is 0.799 nm.

In embodiments the treated graphene oxide consists of graphene oxide and a polymer binder that is selected to bond with an electrically conductive substrate. The polymer binder may be one or more of: PVA, PVB, PMMA or PVP.

In embodiments the interlayer spacing of the treated graphene oxide is 1.00 nm or is 1.10 nm.

In embodiments the functional layer comprises a plurality of sub-layers and at least one of the sub-layers has a first ratio of C═O bonds to C—C bonds and at least one of the other sub-layers has a second ratio of C═O bonds to C—C bonds and the first ratio is higher than the second ratio.

In embodiments each sub-layer has a different ratio of C═O bonds to C—C bonds and the sub-layers are arranged to define a gradient in the ratio of C═O to C—C bonds through the functional layer.

In a further aspect a moisture-electric generating cell comprises:
(a) first and second electrodes; and
(b) the functional layer according to any one of the other aspects; and
wherein the functional layer is disposed between and is electrically connected to the first and second electrodes.

In embodiments, the first electrode is porous to moisture and the second electrode is moisture proof. The second electrode may comprise at least one of FTO, ITO, carbon nanotubes, MXene, graphene; or carbon black. The first electrode may permit moisture penetration through the first electrode and into the functional layer. Moisture comprises H2O molecules. H2O molecules may be present in liquid water or in water vapour. H2O molecules may be present in liquid water and in water vapour at the same time.

In embodiments the first electrode comprises silver or comprises zinc, nickel, aluminium, magnesium, or other metals. Preferably the first electrode may be silver nanowires. The first electrode may be partially covered silver particles, for example from silver paste.

In embodiments a work function of one of the first or second electrodes is higher than the work function of the functional layer and the work function of the other of the first or second electrodes is lower than the work function of the functional layer, to create a work function gradient between the first electrode, functional layer and the second electrode.

In a further aspect, a method of preparing a functional layer for a moisture electric battery cell comprises the steps of:
(a) preparing a mixture of graphene oxide; and,
(b) exposing the mixture to an acid treatment.

In a further aspect, a method of preparing a functional layer for a moisture electric battery cell comprises the steps of:
(a) preparing a mixture of graphene oxide and a polymer binder; and,
(b) exposing the mixture to an acid treatment.

In embodiments the acid treatment comprises applying at least one of hydrochloric acid; nitric acid; or sulphuric acid, to the mixture. The acid treatment may be a liquid treatment or a vapour treatment.

In embodiments, preparing the mixture comprises mixing a solution of graphene oxide with a solution of the polymer binder.

In embodiments, exposing the mixture to the acid treatment comprises mixing a liquid acid into the mixture.

In embodiments, the mixture is a printable solution and the acid treatment involves mixing acid with the printable solution before printing the functional layer onto a substrate.

In embodiments the method comprises applying the acid treatment after the mixture is applied to a substrate.

In embodiments, acid used in the acid treatment has a concentration in the range 0.1 to 98 wt %. Acid used in the acid treatment may have a concentration in the range 1 to 30 wt % to 98 wt %

In embodiments, the method comprises preparing a plurality of mixtures, each mixture comprising a carbon based material and a polymer binder and then exposing each mixture to a different acid treatment so that each mixture has a different ratio C═O bonds to C—C bonds and then stacking the different mixtures to form the functional layer comprising a series of sub-layers and wherein the mixtures are stacked in order of the ratio of C═O bonds to C—C bonds. Preferably the carbon based material is graphene oxide.

In embodiments, the step of preparing the mixture of graphene oxide and the polymer binder comprises dissolving water soluble graphene oxide in water to form a graphene oxide solution and dissolving water-soluble polymer binder in water to form a polymer binder solution and mixing the graphene oxide solution with the polymer binder solution.

In embodiments the graphene oxide solution and the polymer binder solution are mixed in a 1:1 mass ratio. The graphene oxide solution may comprise 10 to 30 mg/mL of graphene oxide. The graphene oxide solution comprises 10 to 30 mg/mL of polymer binder.

In a further aspect the invention provides a moisture electric generating battery cell comprising: a functional layer; a first electrode; a second electrode; where the battery cell is configured to create a moisture absorption gradient across the at least one functional layer when the moisture electric generating battery cell is exposed to moisture.

In embodiments the first electrode and the second electrode comprise different electrode materials. The first electrode and the second electrode have different moisture permeability properties.

In embodiments the first electrode comprises at least one of FTO, ITO, carbon nanotubes, mxene, graphene; carbon nanoparticles, or carbon black. The second electrode may comprise silver nanowires/particles.

In embodiments, the second electrode extends partially over the functional layer.

In embodiments, the first electrode has moisture insulating properties, to resist the ingress of moisture into the functional layer, and the second electrode is porous and allows moisture penetration through the second electrode and into the functional layer.

In a further aspect the invention provides a functional layer for a moisture electric generating battery cell comprising at least one composite layer including a carbon containing material and an binder.

In embodiments the binder is water soluble. The binder may be polyvinyl alcohol (PVA).

In embodiments, the carbon containing material is graphene oxide.

In embodiments the binder facilitates the functional layer binding to at least one electrode. The binder may be electrically conductive. The binder may be electrically non-conductive.

In a further aspect the invention provides a moisture electric generator battery according to any preceding claim wherein the work function of one of the first or second electrodes is higher than the work function of the composite layer and the work function of the other of the first or second electrodes is lower than the work function of the composite layer, to create a work function gradient between the first electrode, composite layer and the second electrode.

In a further aspect the invention provides an electronic device powered by a moisture electric generating cell comprising a functional layer according to any preceding claim. Preferably the electronic device is configured to have a surface positioned in contact with the skin of a subject when in use. Preferably the electronic device is at least one of a sensor; a memory; or a radio transceiver.

In a further aspect the invention provides a battery pack comprising multiple connected moisture generator battery cells comprising functional layers according to another aspect, the moisture generator battery cells may be stacked.

In one aspect the invention provides an electronic device powered by at least one moisture electric generator battery cell according to another aspect.

In an embodiment moisture electronic battery generator is configured to have one surface positioned in close contact with a wearer's skin. The electronic device may comprise at least one of: a sensor; a memory; and/or a radio transceiver.

In a further aspect the invention provides a method for manufacturing a moisture electric generator battery cell comprising the steps of depositing at least one layer of a mixture of a carbon containing material and a binder onto a substrate, the substrate being a first electrode, drying the layer of the mixture and applying a second electrode so the layer is positioned between the electrodes.

In one aspect the invention provides a moisture electric generator battery cell comprising at least one composite layer including a carbon containing material and a binder. The inclusion of a binder has the advantage that it increases the adhesion properties of the layer to a substrate in the battery cell. This can improve the voltage stability of the battery cell. Increased adhesion properties can also improve the current stability of the battery cell. The substrate may be an electrode.

Preferably the binder is a water soluble binder. Preferably the binder does not dissolve in acid.

The layer thickness can be gradually changed by varying the amount of carbon nano material and water soluble binder.

Preferably the carbon containing material is a carbon nano material. The carbon containing material may be organic carbon material. Preferably the carbon containing material is graphene oxide (GO). Graphene oxides (GO) show high specific surface area, abundant oxygen-based groups, and good mechanical properties, which exhibits fast moisture absorption and steady electric output. GO can be modified with oxygen-based groups or inner structure to further improve its electric output. This provides tuneable electrical properties. Graphene oxide has the advantage that it is non-toxic.

Preferably the binder is polyvinyl alcohol (PVA). PVA has abundant hydroxyl group which allows moisture to be absorbed from the environment. Absorption of moisture from the environment absorbs H+ ions which induces potential. PVA also has good viscosity and also improves the attachment of film to a substrate. The improved attachment produces a stable battery having steady electric output across multiple charging cycles. The battery cell provides good voltage retention. PVA can change the spacing between layers of graphene oxide. The spacing between layers of graphene oxide may be increased by PVA. The increase in spacing between the layers may increase the max voltage and current of the battery cell.

Preferably the layer of carbon nano material and water soluble binder comprises a solution of carbon nano material and solution of water soluble binder mixed with a mass ratio of 1:1. The mixture is an ink. The mixture is stable. The mixture can be solution processed. The mixture applied to a substrate using different techniques, including printing and coating techniques.

Preferably the battery cell comprises a first electrode and a second electrode, the at least one layer of a carbon nano material and a water-soluble binder being positioned between first electrode and second electrodes. Electrodes can be deposited using techniques including physical vapour deposition (for example sputtering) or solution processed techniques (for example printing). First and second electrodes may be composed of different materials. Preferably electrically conductive materials.

Preferably the at least one layer is mounted on a substrate. The substrate may comprise the first electrode. This allows the layer of the battery cell to be applied directly onto the bottom electrode. This reduces the size of the battery cell. Preferably the substrate is fluorine doped tin oxide (FTO) glass. Other electrode substrates may be used including ITO coated glass.

The substrate is a flexible substrate, for example carbon cloth. Use of flexible substrates produces flexible battery cells. Flexible battery cells provide opportunities for devices requiring flexibility, for example wearables, IoT devices, electronic skin patches.

The substrate may be stretchable. This can enable battery cells to be used for stretchable electronics.

Preferably the second electrode covers a portion of surface of the layer of carbon containing material and the binder. Preferably the second electrode does not completely cover the surface of the layer. This allows at least part of the layer to be exposed and treatable.

Preferably the at least one layer having at least one of the following properties:
moisture stable;
cyclable electrical properties, this allows the battery cell to be charged, discharged and recharged;
adhesive to a substrate;
adhesive to an electrode;
solution processable, for example printing and coating techniques;
vapour deposition techniques, for example sputtering.

Preferably the at least one layer of a carbon containing material and a binder is treatable to change the oxygen based functional groups in the at least one layer. Changing the oxygen based functional groups can increase the ability of the layer to absorb H⁺ ions. Preferably, the change in functional groups is an increase in the number of C═O bonds in at least one layer. The increase in the number of C═O bonds can allow an increase in the number of H⁺ ions absorbed by at least one layer. This can increase the voltage and/or current produced by the battery cell.

The layer may be treated before being applied to the substrate. The carbon containing material and the binder are mixed with hydrochloric acid before being applied to the substrate. This can produce a generally homogenous distribution of C═O bonds within a solution containing the carbon containing material and binder. When deposited on the substrate, the layer of carbon containing material and binder includes a generally homogeneous distribution of C═O bonds.

Preferably the at least one layer is formed by depositing the composite carbon containing material and binder onto the substrate and then drying, wherein the treatment of the layer to change the oxygen based functional group in the layer is performed by treating the carbon containing material and binder before depositing it onto the substrate. Preferably the carbon containing material and binder is in the form of an ink

The layer may be treated after being applied to the substrate. The layer has a first surface and a second surface wherein the layer is treated on the first or the second surface. The advantage of treating one surface of the layer is that the functional groups at the treated surface are changed. This can create a gradient in the functional groups across the layer. The increase in gradient of functional groups increases the gradient in ability to absorb H⁺ ions. Thus, when exposed to H⁺ ions, this may increase the potential of the battery cell.

Preferably the layer is treated by acidification. Preferably the layer is treated by hydrochloric acid (HCl) acidification. HCl acidification increases the number of C═O bonds. HCl acidification decreases the resistivity of the layer.

The battery cell may include multiple layers of carbon containing materials and binders. Each layer may undergo different treatments. For example, layers may be treated with acids having different concentrations. The different concentrations may produce different amounts of C═O bonds in the layer.

Preferably at least one layer is a film.

Preferably the moisture absorbing properties of the first and second electrodes are different.

Preferably the layer is applied to the substrate by at least one of the following techniques:
spin coating, spray coating, dip coating, drop coating, slot die coating, nanoimprint, ink-jet printing, spray printing, intaglio printing, screen printing, flexographic printing, offset printing, stamp printing, gravure printing and aerosol jet.

The viscosity of the mixture is controllable to facilitate different application processes. The concentration of GO can be changed and organic materials, such as PVA, can be added to improve its application properties and adhesion on different substrates. The viscosity can also be controlled by adding different amounts of organic materials, such as PVA.

Preferably the concentration of hydrochloric acid is between 0.1 to 32 wt %. Preferably the concentration is 32 wt %. 32 wt % produces good electrical properties for the battery cell. Other concentrations of hydrochloric acid may be used. Hydrochloric acid having concentration of 1% has been found to produce stable electric properties over multiple charge and recharge cycles.

Embodiments have a voltage output and a current output wherein at least one of the voltage output and current output is increased upon treating the at least one layer.

In embodiments the interlayer spacing of the at least one layer is increased by treating and increases at least one of the voltage output or the current output of the battery cell. Typically, the GO nanosheet exhibits a multilayer structure, and its interlayer spacing can be tuned to realise different physical and chemical properties.

In a further aspect the invention provides a moisture electric generator battery cell comprising at least one layer including a carbon containing material, wherein the layer is treated to change the oxygen based functional groups in the layer. Changing the oxygen based functional groups can increase the ability of the layer to release H⁺ ions. Preferably, the change in functional groups is an increase in the number of C═O bonds in at least one layer. An increase in the number of C═O bonds can allow an increase in the number of H⁺ ions absorbed by the at least one layer. This can increase the voltage and/or current produced by the battery cell.

Preferably the layer is treated after being applied to the substrate.

Preferably the at least one layer is formed by depositing the carbon containing material onto the substrate and then drying, wherein the treatment of the layer to change the oxygen based functional group in the layer is performed by treating the carbon containing material before depositing it onto the substrate to form the layer. Preferably the layer is an ink and the layer is treated by mixing acid with the ink before depositing the layer onto the substrate.

Preferably the layer includes a binder.

In a further aspect the invention provides a battery pack comprising multiple moisture generator battery cells according to the first or second aspects. In embodiments, the moisture generator battery cells are stacked. In embodiments, the moisture generator battery cells are connected in series. In embodiments the moisture generator battery cells are connected in parallel. Embodiments may include moisture generated battery cells including series and parallel electrical connections between cells.

In a further aspect the invention provides an electronic device powered by one or more moisture electric generator battery cells of the first aspect or the second aspect.

Preferably, the moisture electronic generator battery cell is configured to have one surface positioned in close contact with the wearer's skin.

Preferably, the electronic device further comprising at least one of: a sensor; a memory; and/or wireless communication component/module.

In a further aspect the invention provides a method for manufacturing a moisture electric generator battery cell comprising the steps of depositing at least one layer of a mixture of a carbon containing material and a binder onto a substrate, the substrate being an electrode, drying the layer of the mixture and applying a further electrode so the layer is positioned between the electrodes. The first electrode may be applied to a substrate.

Preferably the second electrode is applied to a portion of the second surface of the layer. Preferably the second electrode does not completely cover the surface of the layer. This allows at least part of the layer to be exposed and treatable.

Preferably the carbon nano material is graphene oxide (GO). Preferably the water soluble binder is polyvinyl alcohol (PVA). Preferably the solution is a mixed solution of GO and PVA in a 1:1 mass ratio.

Preferably the method includes the further step of treating the layer of a carbon nano material and a water soluble binder to increase the number of C═O bonds in the at least one layer. Preferably the layer is treated by acidification. Preferably the acidification is HCl.

In embodiments of the method the step of depositing is performed by at least one of the following techniques:
spin coating, spray coating, dip coating, drop coating, slot die coating, nanoimprint, ink-jet printing, spray printing, intaglio printing, screen printing, flexographic printing, offset printing, stamp printing, gravure printing and aerosol jet.

Preferably the moisture electric generator battery cell having a voltage output and a current output wherein at least one of the voltage output and current output is increased upon treating the at least one layer.

The method wherein the first electrode is a material with similar mechanical properties to the composite layer.

The method wherein the first electrode comprises a material having a similar thermal expansion coefficient to the composite layer.

The method wherein the first electrode comprises carbon nanotubes.

Preferably the first electrode includes at least one of the following properties: waterproof, soft, provides good adhesion on the interface with the composite layer, flexible, lightweight. Similar structure and expansion coefficient to GO so good adhesion on the GO So electrical resistivity of the connection is low to increase conductivity during operation.

Preferably the work function of one of the first or second electrodes is higher than the work function of the composite layer, and the work function of the other of the first or second electrodes is lower than the work function of the composite layer, to create a work function gradient between the first electrode, composite layer and the second electrode.

The method wherein the second electrode has a work function lower than the work function of the composite layer.

The method wherein the second electrode has a work function lower than the work function of the composite layer, and the composite layer has a work function lower than the first electrode.

The method wherein the second electrode comprises a porous material. Preferably the second electrode comprises a material that allows water penetration. Preferably the second electrode comprises silver nanowires.

The method wherein the second electrode comprises zinc.

Applications for the moisture electric generator battery cells include power sources for thin film transistors, memory device (for example RRAM, memristors), large area electronics, IoT devices, sensors, wearable devices, electronic skin patches.

A moisture electric generator battery cell wherein the first electrode has moisture insulating properties, to resist ingress of moisture into the layer.

A moisture electric generator battery cell wherein the first electrode prevents ingress of moisture through the first electrode and into the layer.

A moisture electric generator battery cell wherein the first electrode substantially covers a first surface of the layer.

A moisture electric generator battery cell wherein the first electrode comprises a carbon based conductive material.

A moisture electric generator battery cell wherein the first electrode comprises carbon nanotubes.

A moisture electric generator battery cell wherein the first electrode comprises graphene.

A moisture electric generator battery cell wherein the first electrode comprises carbon black.

A moisture electric generator battery cell wherein electrode is a material with similar mechanical properties to the composite layer.

A moisture electric generator battery cell wherein the electrode comprises a material having a similar thermal expansion coefficient to the composite layer.

A moisture electric generator battery cell wherein the electrode comprises carbon nanotubes.

Preferably the electrode includes at least one of the following properties: waterproof, soft, provides good adhesion on the interface with the composite layer, flexible, lightweight. Similar structure and expansion coefficient to GO so good adhesion on the GO/carbon nanotube interface. So electrical resistivity of the connection is low to increase conductivity during operation.

A moisture electric generator battery wherein the second electrode is in contact with a second surface or the layer.

A moisture electric generator battery wherein the second electrode has a work function lower than the work function of the composite layer.

A moisture electric generator battery wherein the second electrode has a work function lower than the work function of the composite layer, and the composite layer has a work function lower than the first electrode.

A moisture electric generator battery wherein the second electrode comprises a porous material. Preferably the second electrode comprises a material that allows water penetration. Preferably the second electrode comprises silver nanowires.

A moisture electric generator battery wherein the second electrode comprises zinc.

### BRIEF DESCRIPTION OF THE FIGURES

In order that the invention be more clearly understood and put into practical effect, reference will now be made to preferred embodiments of an assembly in accordance with the present invention. The ensuing description is given by way of non-limitative example only and is with reference to the accompanying drawings, wherein:

FIG. 1 shows an embodiment of a moisture electric generator battery cell having a functional layer, a first electrode and a second electrode.

FIG. 2 shows a further embodiment of a moisture electric generator battery cell having a functional layer, a first electrode and a second electrode.

FIG. 3 shows an example of acidification of the functional layer of a moisture electric generator battery cell.

FIG. 4 (a) shows a structure illustration of an embodiment of a MEG.

FIG. 4 (b) shows a photo of device after acid-treatment.

FIG. 4 (c) shows morphology of GO/PVA before acid-treatment.

FIG. 4 (d) shows morphology of GO/PVA after acid-treatment.

FIG. 5 shows voltage output of GO/PVA film acidified by 32 wt. % HCl at different relative humidity (RH).

FIG. 6 shows voltage output of GO/PVA film treated with different HCl concentration. FIG. 6(a) shows voltage retention; FIG. 6(b) shows max voltage output. FIG. 6 (c) shows voltage cycles. FIG. 6 (d) shows current cycles.

FIG. 7(a) shows XRD pattern of GO films and GO/PVA films.

FIG. 7 (b) is the interlayer spacing of GO films and GO/PVA films.

FIG. 8 (a) is XPS spectra of GO/PVA films with and without HCl acidification.

FIG. 8 (b) is the ratio of chemical bonds in GO/PVA films with and without HCl acidification.

FIG. 9 (a) is voltage retention of one unit, two units, four units.

FIG. 9 (b) is current cycles of one unit, two units, four units.

FIG. 9 (c) is max voltage and current of one unit, two units, four units.

FIG. 10 (a) is a photograph of acidified GO/PVA on the carbon cloth and its voltage output at room humidity of 45%.

FIG. 10 (b) is voltage output of flat acidified GO/PVA on the carbon cloth at RH=75%.

FIG. 10 (c) is voltage output of acidified GO/PVA wrapped on glass bottle with a diameter of 2 cm.

FIG. 10 (d) is voltage output of acidified GO/PVA wrapped on glass bottle with a diameter of 1 cm.

FIG. 10 (e) is patter design for device arrays on the FTO glass.

FIG. 10 (f) is a photograph of working calculator powered by two devices in series.

FIG. 11 is an illustration of device fabrication of: (a) Single MEG unit; (b) Four units in series for voltage measurement; and (c) Four units in parallel for current measurement.

FIG. 12 (a) is a photo of GO films on the FTO glass.

FIG. 12 (b) is voltage cycles of GO films at ΔRH=75%.

FIG. 13 shows voltage output of GO/PVA films with different thickness after 32% HCl washing (a) 6.21 μm. (b) 12.23 μm. (c) 15.53 μm. (d) 23.73 μm.

FIG. 14 shows voltage output of films with different area. (a) 0.5×0.5 cm². (b) 1.0×1.0 cm². (c) 1.5×1.5 cm².

FIG. 15 (a) is a FTIR spectra of GO film, GO/PVA film, HCl-washed GO/PVA film.

FIG. 15 (b) is a Raman spectra of GO film, GO/PVA film, HCl-washed GO/PVA film.

FIG. 16 is voltage output of GO/PVA films washed with (a) 80 wt. % acetic acid and (b) 20 wt. % sodium hydroxide. XPS spectra of GO/PVA films washed with (c) 80 wt. % acetic acid and (d) 20 wt. % sodium hydroxide.

FIG. 17 (a) illustrates fabrication of GO/PVA pattern after acidification with 32 wt. % HCl.

FIG. 17 (b) illustrates two units in series for powering practical device.

FIG. 18 is an illustration of fabrication of Ag electrode.

FIG. 19 is a digital photo of experimental setup showing:
(a) Sample chamber for moisture generation and electric connection; and
(b) Keysight system for electric output measurement.

FIG. 20 is an illustration of five units in series for electric output measurement.

FIG. 21 (a) is voltage discharge curve of a single MEG battery cell with 1 resistor unit with 2000 k ohms at RH=75%,

FIG. 21 (b) is voltage retention of 5 connected MEG battery cell for 5.3 hours.

FIG. 21 (c) is voltage cycles of 5 connected MEG battery cell.

FIG. 21 (d) is current cycles of 5 connected MEG battery cell.

FIG. 22 shows MEGs with different functional layers for harvesting moisture from environment. (a) Illustration of abundant and sustainable moisture in the environment. (b) Structure illustration of MEG device. (c) Voltage output of GO film at RH=75%. (d) Voltage output of PVA film at RH=75%. (e) Voltage output of GO/PVA film at RH=75%.

FIG. 23 shows electric output comparison of MEGs with different protonation. (a) Voltage retention of MEGs acidified with different HCl concentration at RH=75%. (b) Vmax of MEGs acidified with different HCl concentration at RH=75%. (c) Voltage output of MEGs acidified by 32.0% HCl at different RH. (d) EIS of MEGs with and without 32.0% HCl acidification at room humidity of 55%. (e) Current output of MEGs acidified with different HCl concentration at RH=75%. The Ag electrode area of single MEG is 0.5×0.2 cm². (f) Voltage output cycle of MEGs acidified with different HCl concentration. The moisture was input by wet N2 to increase electric output until it reached highest value and was then eliminated by dry N2 as one cycle.

FIG. 24 shows characterization and illustration of GO/PVA films in acidification. (a) Electric generation for acidified GO/PVA film. The protons in the functional groups of GO are mobilized by moisture absorption and achieve charge separation by proton migration toward inner layer. Conversely, the migration direction is opposite under the moisture removal and contributes to the charge recombination. (b) XPS spectra of GO/PVA films with and without HCl acidification. (c) The ratio of chemical bonds in the GO/PVA films with and without HCl acidification. (d) Illustration of functional group change in HCl acidification. C—O bonds transform into C═O bonds with better stability after HCl acidification.

FIG. 25 shows theoretical determination of the structural and proton-binding properties of functionalized graphene oxide by using DFT calculations. H binding for O-surface functionalized graphene oxide in the absence (a) and presence (b) of carbon vacancies. H binding for OH-surface functionalized graphene oxide in the absence (c) and presence (d) of carbon vacancies. HCl acidification promotes the formation of carbon vacancies.

FIG. 26 shows electric output of MEGs with different units at RH=75%. (a) Current output of one unit, two units, four units in parallel. The Ag electrode area of one unit is 0.5×0.2 cm². (b) Voltage retention of one unit, two units, four units in series. (c) Vmax and max current output of one unit, two units, four units.

FIG. 27 shows demonstration of MEGs as a power source in various practical application. (a) Voltage output of acidified GO/PVA films wrapped on glass bottle with different curvatures at RH=75%. (b) Vmax of acidified GO/PVA on carbon cloth before and after 2000 bending cycles. (c) Voltage output of charging commercial capacitor by MEG at RH=75%. (d) Electric output of resistor with different resistances connected to MEG at RH=75%. (e) Voltage signals of pressure sensor powered by MEG at room humidity of 55%. (f) Photograph of commercial pressure sensor powered by a single MEG at room humidity of RH=55%. (g) Photograph of working calculator powered by MEG with 2 in series×20 in parallel at RH=75%.

FIG. 28 shows XRD of pristine GO film, HCl-acidified GO film and HNO3-acidified GO film.

FIG. 29 shows XPS spectra of GO film on FTO glass. (a) Pristine GO film without acidification. (b) GO film acidified by HNO3 vapor. (c) The O/C ratio of pristine GO film and GO film acidified by 70 wt. % HNO3 solution and vapor.

FIG. 30 shows the power output of an embodiment of a MEG device.

FIG. 31 shows the power output of an embodiment of a MEG device.

FIG. 32 shows morphology of GO/PVA film. (a) Surface of pristine film. (b) Cross-section of pristine film. (c) Surface of film acidified with 32% HCl. (d) Cross-section of film acidified with 32% HCl.

### DETAILED DESCRIPTION

In illustrative embodiments of the invention a functional layer for a moisture electric generating battery cell is provided. Moisture electric generating devices generate electricity on exposure to moisture due to the interaction of the materials with moisture. Ionization occurs when the H2O molecules facilitate dissociation of functional groups (—OH and —COOH) in the functional layer. Mobilized H⁺ ions are released as charge carriers for electric generation. At least some of the H⁺ ions remain mobile to provide electrical properties of the functional layer.

Moisture comprises H₂O molecules. The H₂O molecules may be in a liquid (water) or water vapour. The term moisture is used in this application and should be understood to refer to H₂O molecules in any state.

The functional layer includes a least one composite layer including a carbon containing material and a binder. The carbon containing material may include carbon nano materials.

An example of a carbon containing material is graphene oxide. Graphene oxide (GO) is known to show high specific surface area, abundant oxygen-based groups, and good mechanical properties, which exhibits fast moisture absorption and steady electric output. Other examples of carbon containing materials include carbon nano-tubes, MXene; or Carbon Nitride (C3N4).

The binder provides interface adhesion between the functional layer and an electrode when an electrode is applied to the functional layer. The binder provides stability of the adhesion between the functional layer and the electrode. Functional layers including binders maintain good adhesion to electrodes over, for example, time periods, electrical testing, exposure to moisture. Improved adhesion provides improved mechanical adhesion between the functional layer and the electrode. Improved adhesion also provides improved electrical stability across multiple charging cycles. Without a binder, the functional layer may exhibit poor stability and reliability of electrical performance. For example, the functional layer may become detached from the electrode. The binder may be electrically conductive or non-conductive.

Binders include electrically insulating polymers. Examples of binders include: polyvinyl alcohol (PVA); polyvinyl butyra (PVB); Poly(methyl methacrylate) (PMMA); Polyvinylpyrrolidone (PVP). PVA has abundant hydroxyl group which allows moisture to be absorbed from the environment. PVA also has good viscosity, which makes it a good candidate for printing. As discussed above in relation to binders, PVA provides stable attachment of the functional layer to an electrode.

In an example embodiment, the functional layer is a composite layer including graphene oxide (GO) and polyvinyl alcohol (PVA). PVA may change the spacing between layers of graphene oxide. The spacing between layers of graphene oxide may be increased by PVA. An increase in spacing between the layers may increase the max voltage and current of a MEG battery cell containing a composite layer of graphene oxide and polyvinyl alcohol.

The inclusion of the binder can increase the interlayer spacing of the carbon containing material, compared with the interlayer spacing of the carbon containing material without the binder. Increased interlayer spacing allows greater penetration of the moisture into the functional layer. Greater penetration of the moisture enables a greater number of H+ ions to be disassociated. However, if the interlayer spacing is increased excessively, then the internal resistance of the functional layer is increased.

In illustrative embodiments of the invention, a functional layer for a moisture electric generating battery cell is provided where the functional layer includes graphene oxide having a ratio of C═O bonds to C—C bonds of more than 1:9. Examples of ratios of more than 1:9 include 2:9, 1:8, 1:5 etc. In some embodiments, the ratio of C═O bonds to C—C bonds is more than 1:8 or is more than 1:7 or is more than 1:6 or is more than 1:5. In some embodiments, the ratio of C═O bonds to C—C bonds is less than 1:1. The ratio of bonds in the functional layer may be measured, for example, using X-ray photoelectron spectroscopy (XPS).

C═O is a double bond between an oxygen atom and a carbon atom. C—C is a single bond between a carbon atom and another carbon atom.

As discussed above, the functional layer may consist of a carbon based material and a binder. The carbon based material may be graphene oxide. The binder may be a polymer binder that is selected to bond with an electrically conductive substrate. Examples of polymer binders include one or more of: PVA, PVB, PMMA or PVP.

In embodiments, the graphene oxide and the polymer binder are a generally homogenous mixture with the graphene oxide and the polymer binder mixed in the mass ratio in the range of 100:1 to 2:1.

In an illustrative embodiment of the invention, a functional layer for a moisture-electric generating cell is provided where the functional layer includes treated graphene oxide having an interlayer spacing that is greater than the interlayer spacing of graphene oxide from which the treated graphene oxide is prepared.

In the functional layer, the treated graphene oxide may have a ratio of C═O bonds to C—C bonds of more than 1:9. Examples of ratios of more than 1:9 include 2:9, 1:8, 1:5 etc. In some embodiments, the ratio of C═O bonds to C—C bonds is more than 1:8 or is more than 1:7 or is more than 1:6 or is more than 1:5. In some embodiments, the ratio of C═O bonds to C—C bonds is less than 1:1. The ratio of bonds in the functional layer may be measured, for example, using X-ray photoelectron spectroscopy (XPS).

In an illustrative example, the interlayer spacing of the treated graphene oxide is ≥0.799 nm.

As discussed above, the functional layer may consist of a carbon based material and a binder. The carbon based material may be graphene oxide. The binder may be a polymer binder that is selected to bond with an electrically conductive substrate. Examples of polymer binders include one or more of: PVA, PVB, PMMA or PVP. The interlayer spacing of the treated graphene oxide may be ≥1.00 nm or ≥1.10 nm.

In an illustrative embodiment, the functional layer comprises a plurality of sub-layers and at least one of the sub-layers has a first ratio of C═O bonds to C—C bonds and at least one of the other sub-layers has a second ratio of C═O bonds to C—C bonds and the first ratio is higher than the second ratio. In embodiments, each sub-layer has a different ratio of C═O bonds to C—C bonds and the sub-layers are arranged to define a gradient in the ratio through the functional layer.

In illustrative embodiments, a moisture electric generating battery cell comprises a functional layer, a first electrode and a second electrode. The functional layer is disposed between and is electrically connected to the first and second electrodes. The moisture electric generating battery cell is configured to create a moisture absorption gradient across the functional layer when the moisture electric generating battery cell is exposed to moisture.

Moisture electric generation battery cells are charged by the reaction of H2O molecules with the functional layer of the moisture electric generation battery cell to create ionisation. The H2O molecules may be provided in a liquid, liquid water, or water vapour. Moisture comprises H2O molecules. During ionization, the moisture is brought into contact with the functional layer and facilitate dissociation of functional groups (—OH and —COOH) of the functional layer. This releases mobilized H+ as charge carrier for electric generation.

By creating a charge gradient across sides of the functional layer, for example where a top side of the functional layer has a high concentration of mobilized H+ ions compared with the concentration of mobilized H+ ions of a bottom side of the functional layer, a charge gradient is created across the functional layer. This charge gradient creates a potential difference across the functional layer. The mobilized H⁺ ions migrate from areas of higher H+ ion concentration to areas of lower H+ concentration generating electric current through the functional layer.

Since the mobilised H⁺ ions are created by the dissociation of functional groups when the functional layer is exposed to moisture, a charge gradient can be created across the functional layer by also creating a moisture absorption differential between the sides of the functional layer. For example, if a top side of a functional layer is exposed to moisture a high concentration of H⁺ are released at the top layer due to the reaction of the functional layer with the moisture. If a bottom layer of the functional layer is not exposed to moisture, or exposed to less moisture, a lower concentration of H⁺ ions are released at the bottom layer. This difference in moisture exposure across the functional layer creates a charge gradient across the functional layer and charges the MEG battery cell.

The charge gradient across the functional layer is related to the voltage output of the MEG battery cell. In general, the greater the protonation gradient across the functional layer, the greater the voltage of the MEG battery cell.

Electrical performance of the MEG battery cell can be improved by creating a moisture absorption differential across the MEG battery cell. In example embodiments, a moisture absorption differential is created across the functional layer of the MEG battery cell when the MEG battery cell is exposed to moisture. This moisture absorption differential produces a moisture absorption gradient across the functional layer. The moisture absorption differential produces an ion gradient across the functional layer when the moisture electric battery cell is exposed to moisture.

In example embodiments, a moisture absorption differential is achieved across the functional layer by providing the first electrode and the second electrode comprising different electrode materials. The electrodes are asymmetrical. Preferably the electrodes are asymmetrical in moisture absorption properties and so the electrodes allow different amounts of moisture to penetrate through the electrodes and to contact the functional layer.

A first electrode of the MEG device is porous to moisture. The second electrode may be impervious to moisture.

The first electrode permits moisture to penetrate through the electrode and into the functional layer. The second electrode is configured to resist the penetration of moisture through the electrode and into the functional layer. The second electrode may prevent the penetration of moisture through the electrode and into the functional layer and allow no moisture through the electrode. The second electrode may be waterproof. The second electrode may provide resistance to moisture penetration by preventing at least some of the moisture from penetrating through the electrode.

The first electrode may comprise silver nanowires or zinc, nickel, magnesium, or other metals.

The second electrode may comprise at least one of FTO, ITO, carbon nanotubes, graphene or carbon black, and MXene.

Factors used to control the absorption of moisture into a functional layer of the battery cell include the design of the electrode and the material used for the electrode.

Selection of the material used for electrodes can affect the electrical performance of the device. Improved performance of the MEG battery device can be created when moisture can penetrate one surface of a functional layer more than another surface of the battery cell. This creates an absorption differential of moisture across the battery cell since once surface of the functional layer is exposed to, and absorbs, more moisture than another surface. The difference in moisture coming into contact with, for example, the top surface and the bottom surface creates an electrical potential across the functional layer.

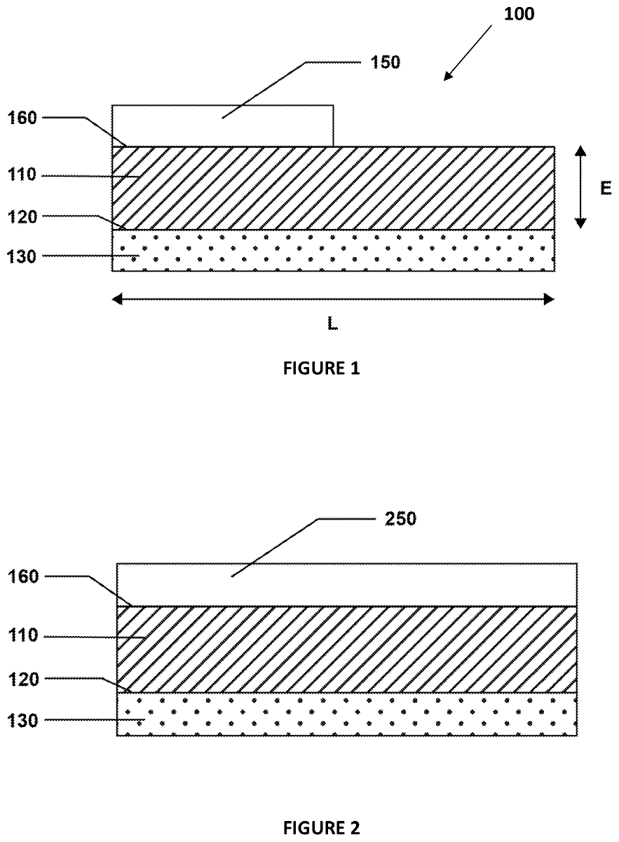

Referring now to FIG. 1, the MEG battery cell 100 includes a composite GO/PVA layer 110. This is the functional layer of the MEG battery cell. First electrode 130 is attached to a first surface 120 of the GO/PVA layer 110. Second electrode 150 is attached to a second surface 160 of the GO/PVA layer 110. In the example of FIG. 1, first surface 120 and second surface 160 are opposite faces of the composite GO/PVA layer. For the purposes of the description electrode 130 is referred to the bottom electrode and electrode 150 is referred to as the top electrode. It is clear that the orientation of the battery cell is not limiting and that these labels are used for the purposes of description only.

The GO/PVA layer 110 has a length dimension (I) and a depth dimension much greater than the dimension of the thickness (E). For example, the thickness of the GO/PVA layer is around 0.5 mm, the length is around 1 cm and the depth is around 1 cm. The surface area of surfaces 120 and 160 are large compared with the thickness.

In the example of FIG. 1, the battery cell is configured to promote absorption of moisture into the top surface 160 of the GO/PVA layer 110 and resist absorption of moisture into the bottom surface 120 of the GO/PVA layer 110. This configuration helps to create a moisture absorption differential between the surfaces of the functional layer when moisture is applied to the battery cell. This promotes an abundance of moisture absorbed into the top surface of the functional layer 160 and lack of moisture absorbed into the bottom surface of the functional layer 120.

In the embodiment of FIG. 1 electrode 150 is configured to cover only a portion of top surface 160 of the GO/PVA layer. The electrode does not fully cover surface top surface 160. The remainder of the top surface of the GO/PVA layer is left uncovered. This allows direct contact of moisture onto the top surface. Larger top electrodes can result in larger current carrying capacity through the GO/PVA to electrode joint. However, if the electrode is too large then water can be prevented from escaping from the GO/PVA layer and also moisture may be prevented from contacting surface through the electrode.

In the embodiment of FIG. 1, the top electrode 150 is silver.

In further embodiments electrode 150 may cover the whole of the top surface 160 of the GO/PVA layer. Such electrodes should be moisture absorbent and allow moisture to penetrate through the electrode and onto the GO/PVA layer. Such electrodes may be porous. In one embodiment the electrode 150 comprises silver nanowires.

In the embodiment of FIG. 1 electrode 130 extends across the bottom surface of the GO/PVA layer. Electrode 130 covers the bottom surface of the GO/PVA layer. Examples of suitable material for the first electrode include carbon based materials, for example carbon nanotubes or graphene. Other suitable materials for the bottom electrode include FTO, ITO, MXene, Au, Pt and carbon black.

By covering the bottom surface, electrode 130 reduces the penetration of moisture into the GO/PVA layer 110 through electrode 130. Preferably electrode 130 prevents penetration of moisture into the GO/PVA layer 110. Preferred electrodes have moisture insulating properties to resist penetration of moisture into the GO/PVA layer.

Preferably, first electrode 130 has moisture insulating properties, to resist penetration of moisture into the GO/PVA layer 110. The penetration of moisture through the first electrode 130 and into the GO/PVA layer is reduced by using an electrode with moisture insulating properties. Preferably the first electrode 130 prevents the penetration of moisture into the GO/PVA layer 110 through electrode 130. In the example of FIG. 1 electrode 130 extends across the entire bottom surface of the GO/PVA layer. Examples of suitable material for the first electrode include carbon based materials, for example carbon nanotubes or graphene. Other suitable materials for the bottom electrode include FTO, ITO, MXene, Au, Pt and carbon black.

Additional resistance to moisture penetration can be provided by mounting the first electrode 130 onto a separate substrate. This can improve the moisture resistive properties of the bottom layer by requiring that any moisture penetrating the bottom layer 120 of the battery cell must first penetrate through the substrate and then penetrate through the first electrode 130 in order to penetrate into the GO/PVA layer.

In the example of FIG. 1, electrode 130 covers the surface of the GO/PVA layer 110. As shown in FIG. 1 the first electrode 130 extends across the full bottom surface of the GO/PVA layer 110. This configuration covers the entire surface from direct contact with moisture. As described above this helps reduce the penetration of moisture across the entire bottom surface of the cell.

The electrical performance of the battery cell is also improved by selecting electrode materials with suitable mechanical properties. Improved electrical performance may be achieved by using electrodes comprising a material with similar mechanical properties to the GO/PVA composite layer, for example a material having a similar thermal expansion coefficient to the composite layer. By having a similar thermal expansion coefficient, the functional layer composite layer 110 and electrode 130 tend to expand and contract proportionally. This maintains adhesion between the composite layer 110 and the electrode 130 during use. A small amount of PVA between the GO and electrodes also improves the mechanical properties. This helps prolong usage of the MEG battery cell by preventing electrical contact failure and increased resistivity of the interface between the electrode and the composite layer over time.

In the example of FIG. 1 the first electrode is carbon nanotube. In further embodiments, the first electrode is graphene, having similar mechanical properties to the GO/PVA composite layer.

In embodiments in which the functional layer is pure graphene oxide, a small amount of PVA or other adhesive may be applied between the functional layer and the electrode to improve adhesion.

A further benefit of the first electrode 130 extending across the entire surface of the GO/PVA layer 110 is that the contact area of the GO/PVA layer 110 and the electrode 130 is increased compared with an electrode which partially extending across the GO/PVA layer. This greater contact area results in an increased surface area of the electrical joint. The greater contact area can reduce the electrical resistivity of the joint.

Preferably, the bottom electrode 130 includes one or more of the following properties: moisture repellent, waterproof, moisture proof, soft, provides good adhesion on the interface with the composite layer, flexible, lightweight, similar thermal expansion coefficient to the composite layer, good adhesion on the GO/carbon nanotube interface, highly conductive, flexible.

The considerations for the top electrode 150 are different from those of bottom electrode 130. To produce a moisture gradient across the functional layer of the MEG battery cell, absorption of moisture into top surface of 160 of GO/PVA layer is promoted.

In an embodiment shown in FIG. 1, electrode 150 is configured to cover only a portion of top surface 160 of the GO/PVA layer. The remainder of the top surface is left uncovered and exposed to allow direct contact of moisture onto the top surface when the MEG battery cell is exposed to moisture. Electrode 150 may be porous. Electrode 150 may be porous to moisture. Larger top electrodes, having larger contact area with the functional layer, can result in larger current carrying capacity through the GO/PVA to electrode joint. However, if the electrode is too large then water can be prevented from escaping from the GO/PVA layer and also moisture may be prevented from contacting the surface through the electrode.

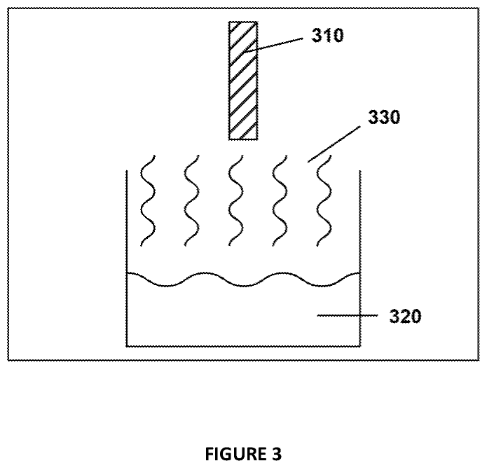

Shown in FIG. 2 is a further embodiment of a MEG Battery Cell. The embodiment of FIG. 2 includes the same GO/PVA functional layer 110 and first electrode configuration 130 as described above in relation to FIG. 1. In FIG. 2, the second electrode 250 is porous. Second electrode 250 is porous to allow penetration of moisture. Second electrode 250 covers the surface 160 of GO/PVA functional layer. In further embodiments the second electrode may partially cover the surface 160 of the functional layer.

The porosity of electrode 250 allows moisture to penetrate through the electrode and into the top surface of GO/PVA layer 110. Consequently, larger electrodes can be used which cover a greater portion of the top surface of the GO/PVA functional layer but allow absorption of moisture into the GO/PVA layer. The moisture is absorbed into and passes through electrode 250 and into the surface of functional layer 110. Porous electrodes increase the contact area between the electrode 250 and the GO/PVA surface to help achieve higher current. In the example of FIG. 2, the second electrode 250 covers the top surface of the GO/PVA layer 160.

In the example of FIG. 2, the electrode 250 is a silver nanowire based electrode.

More generally, examples of a porous second electrode include electrodes containing metal nanowires. Preferably, the metals should have a good resistance to corrosion and smaller work function compared with GO. The metal nanowires have a network structure so moisture can penetrate through the electrode and into the GO/PVA layer.

The top electrode is applied as an ink. Preferably the concentration of the ink includes between 0.1 wt % to 20 wt % of sliver nanowires. In an example embodiment, the ink is a 1 wt % silver nanowires ink. The ink is drop coated or gravure coated or screen coated on the MEG device.

In an illustrative embodiment, a moisture-electric generating cell is provided where the work function of one of the first or second electrodes is higher than the work function of the functional layer and the work function of the other of the first or second electrodes is lower than the work function of the functional layer, to create a work function gradient between the first electrode, functional layer and the second electrode.

Electrical performance of a moisture electric generating cell and selection of electrode material is also affected by the work function of the materials. GO has a work function of around 4.7 to 4.9 eV.

Suitable electrodes configuration can induce a Schottky barrier at the electrodes/GO interface that can match well with the direction of diffusion of protons in GO, thus enhancing the voltage output. In particular, GO has a work function around 4.7 to 4.9 eV, so a top electrode with smaller work function would prevent the recombination of electrons and protons. An example of a suitable material is zinc. Zinc which has a work function of 4.3 which is much smaller than that of GO. In an example embodiment, the top electrode is zinc foil, having a thickness of around 0.5 mm.

Preferably the bottom electrode has a work function higher than the GO/PVA layer. This creates a work function gradient across the MEG battery device from the first electrode to the GO/PVA functional layer to the second electrode.

The work function gradient may increase from the first electrode to the second electrode or increase from the second electrode to the first electrode. So the work function of one electrode is higher than the work function of the GO/PVA layer and the work function of the other electrode is lower than the work function of the GO/PVA layer. When the work function of one of the first or second electrodes is higher than the work function of the composite layer, and the work function of the other of the first or second electrodes is lower than the work function of the composite layer, a work function gradient is created between the first electrode, composite layer and the second electrode.

Preferably the electrically insulating polymer is water soluble. GO solution and binder solution are mixed with a mass ratio of 1:1 by sonication. Other mixing mass ratios could be used from 100:0 to 100:200. A 1:1 ratio is found to provide a good attachment of GO/PVA to the substrate and electrodes.

Preferably the GO and binder solution is in the form of an ink. The ink is printable.

The following description describes fabrication techniques and considerations for a Moisture-Electric Generator battery cell. The battery cell includes at least one functional layer between two electrodes. The functional layer may comprise graphene oxide. The functional layer may comprise a composite layer including a carbon containing material and binder. The carbon containing material may be Graphene Oxide (GO). The binder may be polyvinyl alcohol (PVA).

Various configurations of electrodes and substrates are described for different embodiments and fabrication techniques. In some embodiments the functional layer is deposited onto an electrode substrate so the bottom surface of the layer contacts the electrode substrate. A further electrode is positioned onto the top surface of the layer to complete the battery cell.

The binder improves the adhesion of the layer to the electrodes.

Other materials may be used in place of GO and/or PVA. Carbon nanotubes are an alternative to GO. Oxygen containing polymers with tuneable electric properties may be used in place of Graphene Oxide.

The functional group density of the MEG battery cell can be tuned to change the electrical properties of the MEG battery cell. Functional group density can be tuned by acid treatment.

Acid treatments are described below and include immersion treatments and a vapour treatment. Acid treatment may be applied before or after the functional layer is deposited on an electrode. Acid treatment may be applied to the functional layer while the layer is in liquid form, or when the functional layer is in a film form.

In an example method, GO powder was synthesised by the oxidation of graphite powder according to the Hummers method. 20 mg/mL GO solution was obtained by dispersing GO powder in the distilled water with sonication for 30 mins. 20 mg/mL PVA solution was obtained by dissolving PVA powder (Mw 13000-23000) in distilled water at 90° C. for 30 min.

In some samples, the fluorine doped tin oxide (FTO) glass was cut into 2.5×2.5 cm² pieces and was used as substrate/bottom electrode. Other electrically conducting substrates may be used in place of FTO coated glass, for example ITO coated glass or other conductive electrode materials.

In some further embodiments different sized substrates/electrodes were used. In these embodiments the fluorine doped tin oxide (FTO) glass was cut into 1.0×2.0 cm² pieces and was used as substrate/bottom electrode.

FTO glass was then cleaned with ethanol and deionized water, followed by ultraviolet radiation for 30 min. The ultraviolet radiation can remove organic impurities on the substrate.

GO solution and PVA solution are mixed with a mass ratio of 1:1 by sonication. Other mixing mass ratios could be used from 100:0 to 100:10. The 1:1 can provide a good attachment of GO/PVA to the substrate.

The mixture and was dried directly onto the FTO glass at 50° C. for 12 h to form 1×1 cm² GO/PVA film. Further layers of the mixture can be applied to increase the thickness of the GO/PVA layer. Typically, further layers are deposited after the previous layer has been dried. In other embodiments the layers may be different mixtures.

The mixture may be applied to the substrate using different methods. In one example method, the mixture may be applied using spin coating or drop coating techniques. Printing techniques may also be used to apply the mixture onto the substrate, including screen printing. Printing techniques are particularly beneficial when the mixture is an ink.

The concentration of the material can be controlled. This will affect the porosity.

In other embodiments, carbon cloth is used as an electrode substrate, being electrically conductive and flexible. The carbon cloth was soaked in the GO/PVA solution for 10 mins and was dried for 12 h. Other soaking periods may be used. Different drying periods may be used.

The top electrode may be applied to the film before or after acid treatment of the MEG battery cell (described below).

There are several considerations for electrode configuration which can affect the performance of the MEG battery device, these include the moisture absorption and repellent properties of the electrodes, mechanical properties of the electrodes, work function of the electrodes. These are now discussed in relation to each electrode:

In further embodiments a method of preparing a functional layer for a moisture electric battery cell is provided. The functional layer is provided as a mixture. The mixture is exposed to an acid treatment. The mixture may be solution of graphene oxide. The mixture may be a mixture of graphene oxide and a polymer binder.

The acid treatment comprises applying an acid to the mixture. Preferably the acid is at least one of hydrochloric acid; nitric acid; or sulphuric acid. The acid treatment may be a liquid treatment or a vapour treatment.

Preferably, preparing the mixture comprises mixing a solution of graphene oxide. The mixture may comprise mixing a solution of graphene oxide with a solution of the polymer binder. Exposing the mixture to the acid treatment comprises mixing a liquid acid into the mixture. The mixture is a printable solution and in one embodiment the acid treatment involves mixing acid with the printable solution before printing the functional layer onto a substrate.

In other embodiments, the method comprises applying the acid treatment after the mixture is applied to a substrate. The substrate may be an electrode.

The acid treatment may be applied while the mixture is in a liquid form. The acid treatment may be applied when the mixture is in a solid form, for example as a functional layer deposited onto an electrode.

In example embodiments, the acid used in the acid treatment has a concentration in the range 0.1 to 70 wt %. The acid used in the acid treatment may have a concentration in the range 1 to 30% to 50 wt %. The concentration of the acid may be selected based on the acid used in the acid treatment.

In embodiments, the acid treatment has the effect of increasing the ratio of C═O bonds to C—C bonds in the functional layer.

In embodiments, the method comprises preparing a plurality of mixtures. Each mixture comprises graphene oxide and the polymer binder and then exposing each mixture to a different acid treatment so that each mixture has a different ratio C═O bonds to C—C bonds. The different mixtures are then stacked to form the functional layer comprising a series of sub-layers and wherein the mixtures are stacked in order of the ratio of C═O bonds to C—C bonds. The functional layer comprising a series of sublayers is positioned between a top electrode and a bottom electrode to form a MEG battery cell.

The step of preparing the mixture of graphene oxide and the polymer binder comprises dissolving water soluble graphene oxide in water to form a graphene oxide solution and dissolving water-soluble polymer binder in water to form a polymer binder solution and mixing the graphene oxide solution with the polymer binder solution.

The graphene oxide solution and the polymer binder solution are mixed in a 1:1 mass ratio.

The graphene oxide solution may comprise 10 to 30 mg/mL of graphene oxide.

The graphene oxide solution may comprise 10 to 30 mg/mL of polymer binder.

In an example embodiment, to treat the MEG, MEG battery cell was immersed in hydrochloric acid for 10 mins. Then MEG battery cell was washed with distilled water for 10 mins. MEG was then dried at 50° C. for 12 h for electrical measurement. Various samples were immersed in hydrochloric acid having different concentrations and the electrical properties of each of the samples were then tested. Hydrochloric acid having concentration of 0.5%, 1%, 16% and 32 wt % were used.

In the example embodiment, the bottom surface of the GO/PVA layer was attached to the conductive substrate. The conductive substrate is liquid resistant and so resists the acid from penetrating through the conductive substrate and onto the bottom surface of the GO/PVA layer. Thus, it is expected that the bottom surface of the layer was not directly exposed to the hydrochloric acid.

Preferably, the MEG battery cell was treated before the top electrode was applied to the GO/PVA layer. So the first electrode was applied to the GO/PVA layer and the first electrode and GO/PVA sample was treated. In this example the sample was treated with a single electrode attached only.

A benefit of applying the second electrode to the functional layer after applying the acid treatment is that during treatment the surface of the functional layer is not covered by an electrode. This means that the surface area of the film to which the acid will contact, is not reduced. Another benefit of applying the second electrode after the acid treatment has been applied is that the acid will not damage the second electrode.

In other embodiments the acid treatment is applied after the second electrode has been applied to the functional layer.

In the example embodiment the method steps included:
preparing a GO/PVA mixture;
depositing the GO/PVA mixture onto an electrode to form a GO/PVA layer;
applying the acid treatment;
apply a second electrode to the GO/PVA layer.

As discussed above, in other embodiments the GO/PVA solution can be mixed with acid before applying to the substrate. In this case, the GO/PVA mixture is mixed with the acid. The GO/PVA mixture may be an ink. The solution is then deposited onto the conductive substrate after the acid treatment.

In other embodiments, multiple layers of solution may be deposited. A first layer is deposited onto the conductive substrate. After the layer is dry, a further layer is deposited on top of the first layer. After this further layer is dry, additional layers may be deposited. Depending on the required electrical properties, each layer may include the same solution or different solutions. For example a first layer may comprise a solution which has not been mixed with acid. A further layer may be deposited onto the first layer, where the further layer comprises a solution mixed with acid having a particular concentration, for example 1%. Further layers may comprise solutions mixed with different concentrations of acid. The multiple layers together form the functional layer.

In an alternative embodiment, an alternative acid treatment technique is used. In this technique the MEG battery cell is treated by acid vapour. The acid vapour technique can be used in place of the acid immersion technique described above. Different vapour treatments may be used.

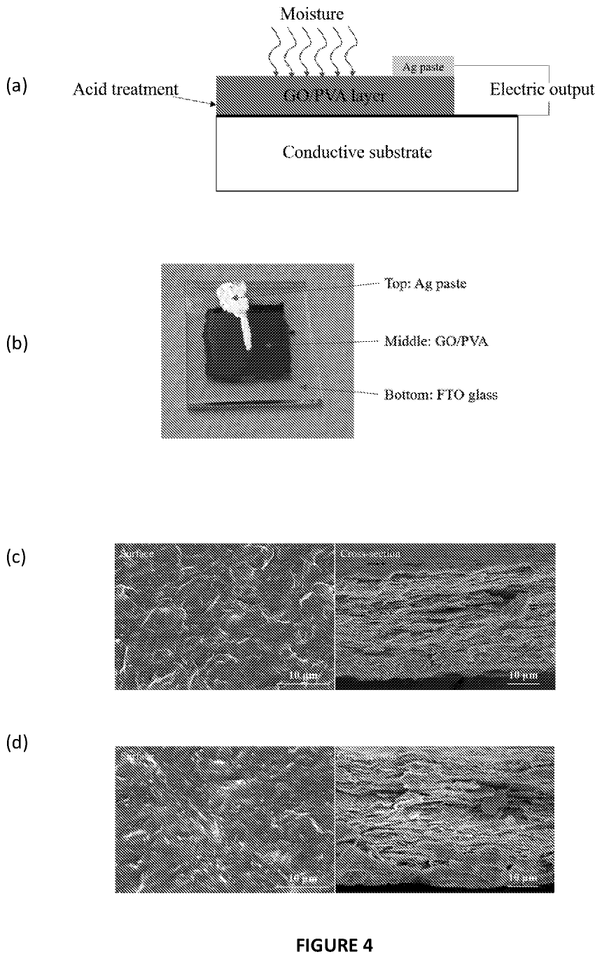

In an example embodiment, the functional layer 310, for example the GO/PVA layer, is hanged over an HCl solution 320 as shown in FIG. 3. HCl vapour 330 is emitted from the HCl solution 320 and contacts the GO/PVA layer 310. The acid vapour is absorbed into the surfaces of the GO/PVA layer. Various procedures may be used to generate vapour from the HCl solution, for example: the MEG materials can be put on the top of HCl solution and the container is heated. For example the HCl solution may be heated from room temperature to 100 degrees C.

In FIG. 3, no electrode or substrate is shown. In further embodiments the GO/PVA layer is deposited onto an electrode before acid treatment. The electrode may be an electrically conducting substrate. The electrode may be deposited onto a substrate and the functional layer may be deposited onto the electrode before acid treatment.

Preferably, the MEG battery cell and the acid are contained within a sealed chamber to prevent escape of the HCl vapour.

Preferably the HCl solution may be 32 wt % concentration. Different concentrations of HCl solution may be used. For example, 0.5 wt %, 1 wt %, 16 wt %, 32 wt %. Concentrations may be used in the range 0.5 wt % to 36 wt %. Preferably the concentration is in the range of 20 wt % to 36 wt %. Most preferably the concentration is in the range of 30 wt % to 36 wt %.

In an example treatment the exposure time is 1 hour. Longer or shorter treatment times may be used to change the exposure time of the MEG battery cell to the HCl vapour.

After exposure to the HCl vapour the MEG battery cell is dried. For example, the battery cell may be placed in an oven for drying.

Benefits of the vapour treatment compared with the immersion technique include that liquid, in particular, water molecules from the HCl solution are less likely to penetrate into the MEG battery cell. Water molecules penetrating into the battery cell can evaporate during drying and produce cracks in the GO/PVA composite layer damaging the battery cell and reducing the electrical performance of the battery cell.

Further benefits of the vapour treatment include reduced drying times compared to immersion of the battery cell in HCl solution.

Other acids may be used to treat the functional layer. HNO3 (nitric acid) may be used. Typically nitric acid is available between 0.1 to 98 wt %. Sulphuric acid may also be used for acid treatment. Typically sulphuric acid is available between 0.1 wt % and 98 wt %.

Section 1: Samples and Results

The following Section 1 describes a first series of samples and results:

Materials

GO powder was synthesised by the oxidation of graphite powder according to the Hummers method. 20 mg/mL GO solution was obtained by dispersing GO powder in the distilled water with sonication for 30 mins. 20 mg/mL PVA solution was obtained by dissolving PVA powder (Mw 13000-23000) in distilled water at 90° C. for 30 min.

Fabrication of MEG

The FTO glass was cut into 2.5×2.5 cm² pieces and was used as substrate/bottom electrode. Other electrically conducting substrates may be used in place of FTO coated glass, for example ITO coated glass or other conductive electrode materials.

GO solution and PVA solution are mixed with a mass ratio of 1:1 by sonication. Other mixing mass ratios could be used from 100:0 to 100:10.

The mixture and was dried directly onto the FTO glass at 50° C. for 12 h to form 1×1 cm² GO/PVA film. Further layers of the mixture can be applied to increase the thickness of the GO/PVA layer. Typically, further layers are deposited after the previous layer has been dried.

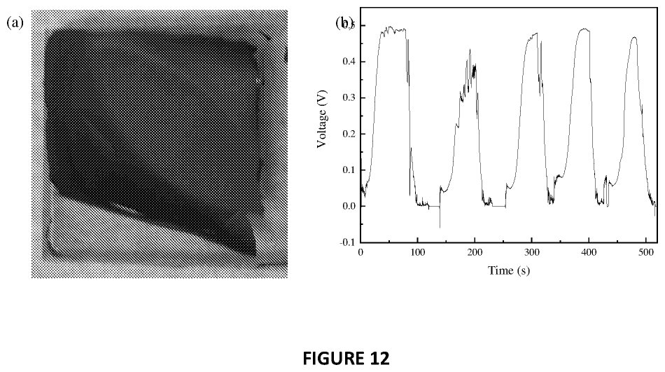

The rest exposed area of FTO glass was cover by the insulative tape and spread Ag paste as the top electrode. This process is described in more detail below with reference to FIG. 12.

In an alternative embodiment carbon cloth is used as an electrode substrate, being electrically conductive and flexible. The carbon cloth was soaked in the GO/PVA solution for 10 mins and was dried for 12 h.

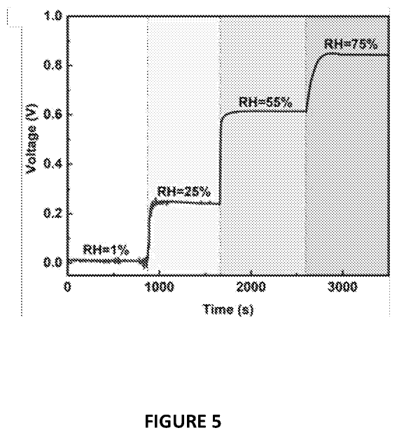

FIG. 4(a) shows a schematic cross-sectional representation showing the structure of a MEG battery cell. FIG. 4(b) shows a photograph of the MEG battery cell after acid treatment. GO/PVA layer is deposited onto conductive substrate so the bottom surface of the GO/PVA layer contacts the conductive substrate. In the example described above the conductive substrate is FTO coated glass. A top electrode is applied to the top surface of the GO/PVA layer. In the example the top electrode is Ag paste.

FIG. 12(a) shows the steps for applying the second (top) electrode onto the GO/PVA layer of the battery cell. FIG. 12(a) represents a top view of a sample for which GO/PVA film has been deposited onto FTO glass substrate and acidified. In the example of FIG. 12(a) the GO/PVA film partially covers the FTO glass substrate. In other embodiments the film may completely cover the substrate. In other embodiments the film may cover other proportion of the substrate.

Insulation is applied over part of the exposed substrate. The top electrode is then deposited onto the top layer of the film. The top electrode is insulated from the bottom electrode to avoid short circuiting the battery cell. In the example of FIG. 12, silver (Ag) paste is used for the top electrode.

The rest exposed area of FTO glass was cover by the insulative tape and spread Ag paste as the top electrode. This process is described in more detail below with reference to FIG. 12.

Acid Treatment of MEG

The treat the MEG, MEG battery cell was immersed in hydrochloric acid for 10 mins. Then MEG battery cell was washed with distilled water for 10 mins. MEG was then dried at 50° C. for 12 h for electrical measurement. Various samples were immersed in hydrochloric acid having different concentrations and the electrical properties of each of the samples were then tested. Hydrochloric acid having concentration of 0.5%, 1%, 16% and 32 wt % were used.

Since the bottom surface of the GO/PVA layer was attached to the conductive substrate, it is expected that the bottom surface of the layer was not directly exposed to the hydrochloric acid.

An advantage of treating the MEG battery cell before applying the top electrode to the film is that after applying the top electrode to the film, the surface area of the film attached to the top electrode is protected from the acid treatment. Meaning that the surface area of the film to which the acid will contact, and change the oxygen groupings, is reduced. Acid will not make contact with that part of the surface connected to the top electrode.

Electrical Test

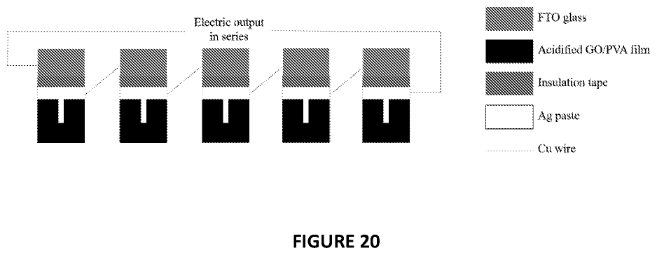

As an example, the top and bottom electrodes of MEG were connected to a precision source/measure unit for electric output measurement (FIG. 20(b)). In the example, a Keysight B2902A measurement unit was used.

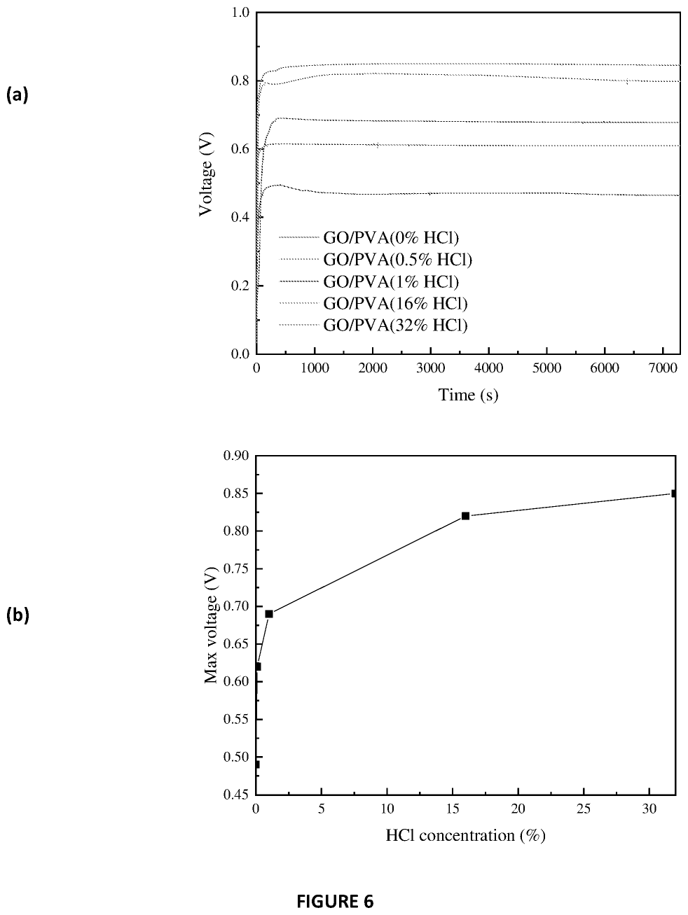

Electrical measurements were taken on the battery cell in environments having different relative humidity (RH). Wet N₂ and dry N₂ were used to control the RH in the sample chamber. For electric retention measurement, moisture was input by wet N₂ to increase the RH (up to 75% RH) and electric output until it reached highest value and was stopped for retention measurement. For the measurement of an electric cycle, moisture was input by wet N₂ to increase the RH and electric output until it reached highest value and was eliminated by dry N₂ (Up to 0% RH) to decrease the RH and electric output until it reached the lowest value. The voltage and current output of multiple battery cells were measured by connecting the battery cells in series and parallel. Measurements are shown in FIG. 5 for the voltage retention for a battery washed in 32% HCl at 1%, 25% and 55% relative humidity. This shows that as the relative humidity increases, voltage output by the MEG battery cell increases.

Result and Discussion

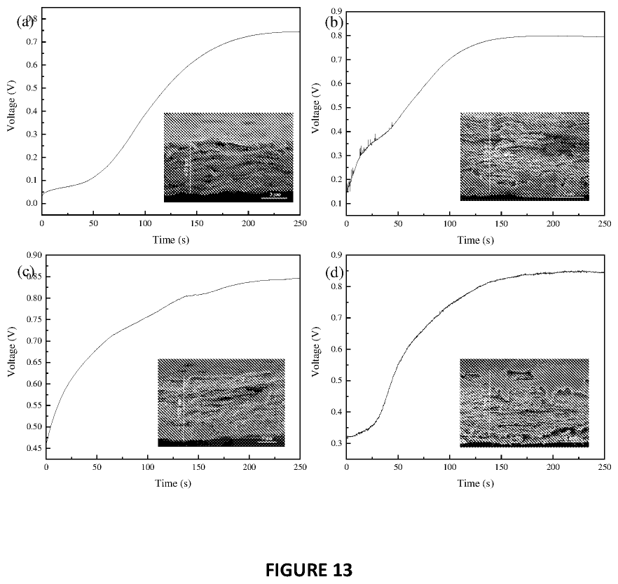

FIG. 4a shows the structure illustration of MEG, which is a relatively simple structure for the electric generation. The device photo in the FIG. 4b exhibits uniform surface and good attachment of GO/PVA film on the FTO glass compared with the GO film in FIG. 13a, which shows weak attachment and wrinkle. The morphology of GO/PVA films with a thickness of 15.53 μm after HCl acidification (FIG. 4d) shows smooth surface and dense layer-structure due to the addition of PVA, which is similar with the morphology of GO/PVA film before acid washing (FIG. 4c). The intact and uniform morphology of GO/PVA films contributes to the stable electric output in the long-term use.

The voltage output of GO/PVA film acidified by 32 wt. % HCl was recorded at different RH (FIG. 5). The max voltage of MEG is 0.01 V (Relative Humidity (RH)=1%), 0.25 V (RH=25%), 0.61 V (RH=55%), respectively. Thus, MEG shows almost no voltage output at RH=1% and increased voltage output at higher RH, which demonstrate that RH is closely related to the electric generation. The higher RH contributes to more absorbed water and greater H⁺ gradient in MEG, which leads to higher voltage output.

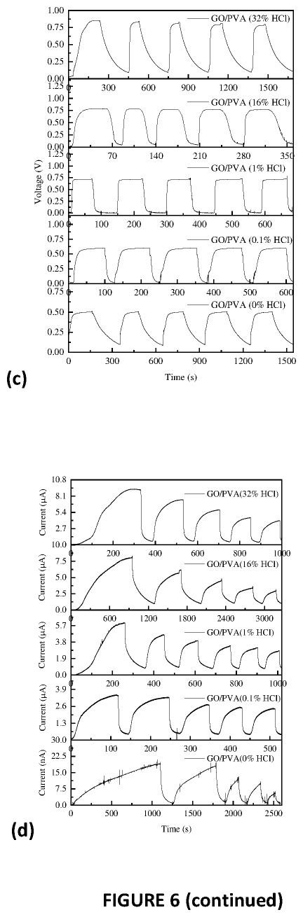

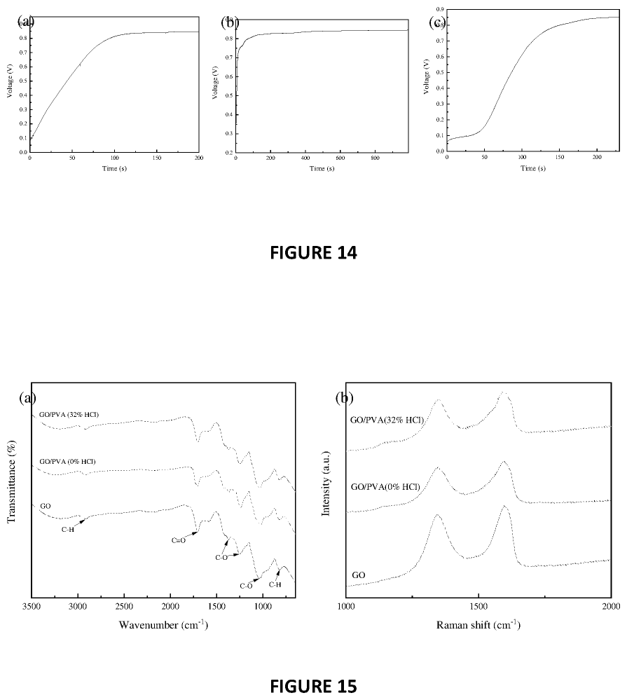

The voltage output of GO/PVA film acidified by HCl solution at different concentrations is shown in FIG. 6b. The max voltage increases with thickness (0.74 V, 0.8 V and 0.85 V for the films with a thickness of 6.21 μm, 12.23 μm, 15.53 μm, respectively) and shows no obvious increase for the films thicker than 15.53 μm (FIG. 13). The thin films facilitate water permeation and decrease H⁺ gradient across the Go/PVA layer, which leads to lower voltage output. Besides, GO/PVA films with different areas (0.5×0.5 cm², 1.0×1.0 cm², 1.5×1.5 cm²) show similar max voltage value (FIG. 14), which demonstrates that voltage is related to the charged ion gradient instead of film area and high voltage can be generated with very small area.

Voltage retention can be utilised to evaluate the long-term performance of the device (FIG. 6a). The voltage of GO/PVA film increases after exposing the film to the moisture and shows no obvious degradation over 2 h (RH=75%). These results exhibit better electric performance in generating stable and persistent voltage output compared with the performances in other GO-based MEG.

The max voltage of GO/PVA increases with HCl concentration and increases slowly when HCl concentration is higher than 16%. The max voltage of GO/PVA film without HCl acidification is about 0.49 V, which is almost same with the GO film without HCl acidification (FIG. 6b). The max voltage of GO/PVA film acidified with 32% HCl is 0.85 V, which is much higher than the max voltage of film without HCl acidification (0.49 V). Thus, the voltage output of acidified GO/PVA films is closely related to the HCl concentration. HCl acidification can be employed as a facile and effective approach to greatly improve the voltage output of GO/PVA film.

The voltage cycles of GO/PVA films have also been investigated to evaluate the stability of MEG (FIG. 6c). The voltage cycles of GO film (FIG. 12b) are not as stable as GO/PVA film because PVA can provide a stable structure and good attachment of film to the substrate. GO/PVA films show similar voltage output in each cycles and same max voltage output, which demonstrates the GO/PVA films can generate stable voltage output.

FIG. 6d exhibits short-circuits current (I_{sc}) of GO/PVA films, which increases with the concentration of HCl (I_{sc}=9.28 μA, 8.32 μA, 6.05 μA, 3.51 μA, 19.71 nA for films acidified with 32%, 16%, 1%, 0.5%, 0% HCl, respectively). The max current of GO/PVA films acidified with 32% HCl is about 9.28 μA and is significantly higher than the max current of films without HCl acidification (19.71 nA), which results from the resistance decrease after H⁺ introduction in HCl acidification. The GO/PVA films are supposed to be non-conductive due to the large amount of functional groups attached to the carbon plane. However, the resistivity of GO/PVA film after acidification with 32% HCl decreased to 0.9-1.2 MΩ, which is beneficial for better electric performance.

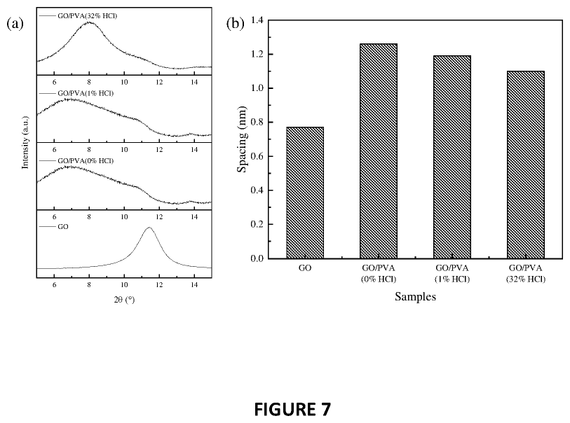

The diffraction peak of GO/PVA film shows a lower angle than that of GO films and shifts to the higher angle after increasing HCl concentration (FIG. 7a). The interlayer spacing of GO/PVA film can be calculated with diffraction angle (FIG. 7b).

The GO/PVA films shows a higher interlayer spacing than GO films, where spacing is 0.77 nm for GO film, 1.26 nm for GO/PVA film, 1.19 nm for GO/PVA (1% HCl) film, 1.10 nm for GO/PVA (32% HCl) film. The polymer molecules of PVA may enter into the interlayer of GO, where carboxyl groups from GO may react with hydroxyl groups in the crosslinking. The crosslinking between the GO and PVA bridges the adjacent GO sheets and enlarge interlayer spacing, which may explain GO/PVA films shows a higher interlayer spacing than GO films.

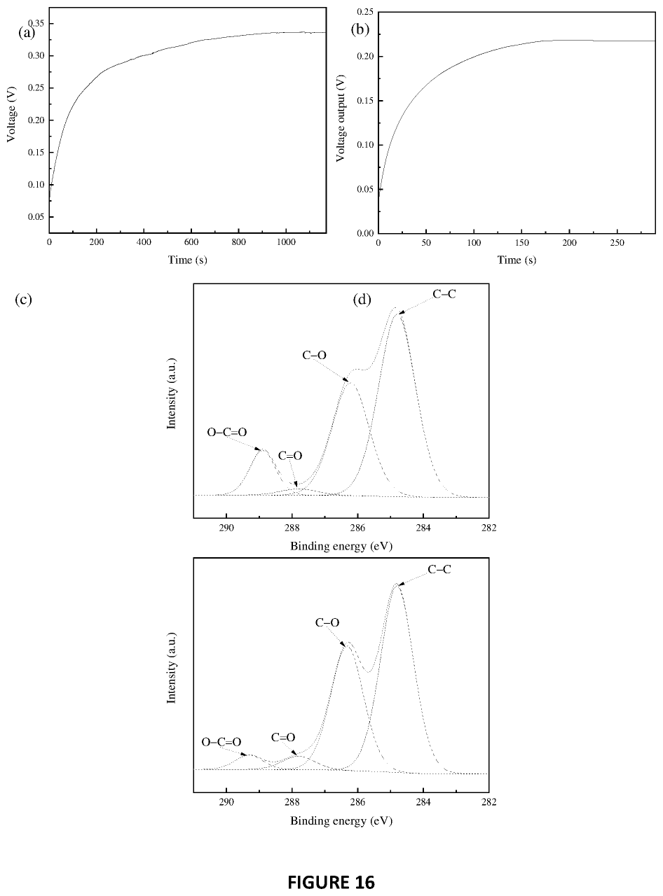

Besides, the spacing of GO/PVA films decreases after HCl acidification. The shortened spacing of GO/PVA film acidified with HCl may result from the charged ions (H⁺) induced by HCl acidification as H⁺ can be absorbed by the oxygen-based groups and inhibit crosslinking of GO and PVA. The FTIR spectra of GO/PVA film and GO/PVA (32% HCl) film are almost the same with the spectra of GO films (FIG. 15a). Due to the addition of PVA, the Raman spectra of GO/PVA film and GO/PVA (32% HCl) film are flatter than the spectra of GO films (FIG. 15b), which demonstrates that PVA is not washed off by the distilled water or HCl in our work.

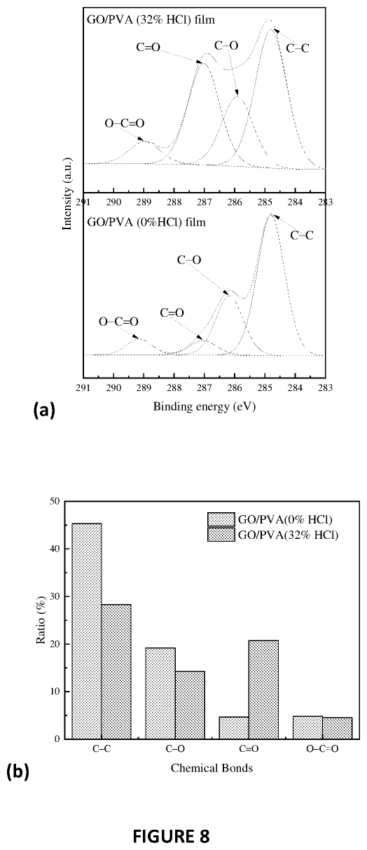

The oxygen-based functional groups are closely related to the moisture absorption and electric generation, which can be characterised with C 1s region in XPS. To investigate the effect of HCl acidification on the change of functional groups for the increased voltage output, the GO/PVA films with and without HCl acidification are analysed with in FIG. 8. The C 1s peaks in the GO/PVA (0% HCl) with binding energy of 284.8 eV, 286.2 eV, 287.0 eV, 289.2 eV represent C—C (45.29 at. %), C—O (19.18 at. %), C═O (4.67 at. %), O—C═O (4.84 at. %). The C 1s peaks in the GO/PVA (32% HCl) with binding energy of 284.8 eV, 285.9 eV, 287.0 eV, 289.0 eV represent C—C (28.30 at. %), C—O (14.26 at. %), C═O (20.75 at. %), O—C═O (4.49 at. %). Thus, the ratio of C—O bond decreases after HCl acidification, while the ratio of C═O bond increases after HCl acidification. The C/O ratio in the GO/PVA films decreases from 2.96 to 2.12 after 32% HCl acidification, which demonstrates an acid oxidization occurs in the acid washing. In HCl acidification, epoxy groups can be arranged in a line, which leads to the rupture of C—C bonds. The epoxy chain tends to be oxidized into epoxy pairs and convert into carbonyl pairs as carbonyl groups are more stable in this conditions. The C═O with stronger polarity are stronger than C—O in attracting H⁺ and forming hydrogen bonds. Thus, the higher voltage output could be attributed to more C═O bonds, which can attract more H⁺ for electric potential generation.

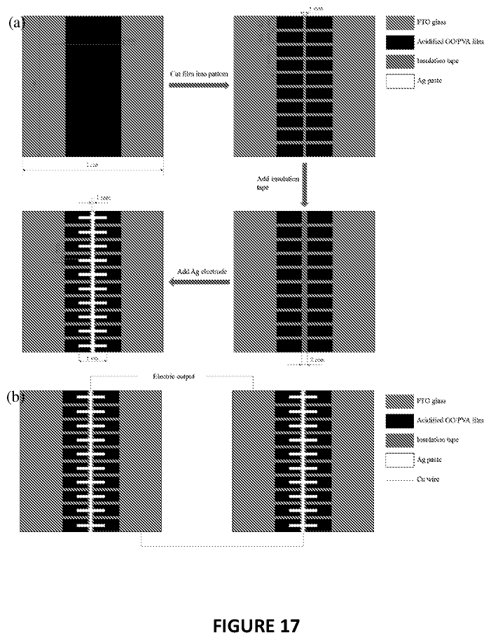

The oxygen-based groups in GO/PVA films washed with acetic acid and NaOH are also investigated in FIG. 16c and FIG. 16d, respectively. The GO/PVA films washed with acetic acid show C—C (35.96 at. %), C—O (22.28 at. %), C═O (1.27 at. %), O—C═O (6.13 at. %), while GO/PVA films washed with NaOH show C—C (37.86 at. %), C—O (25.24 at. %), C═O (2.74 at. %), O—C═O (2.47 at. %). The max voltage of GO/PVA films washed with acetic acid and NaOH is 0.34 V and 0.22 V, respectively, which is relatively lower than max voltage of films acidified with HCl as the ratio of C═O in GO/PVA films washed with acetic acid and NaOH is lower. Thus, the ratio of C═O is related to the voltage output of GO/PVA films. Moreover, the higher C/O ratio in the acidified films contributes to the lower resistivity of GO/PVA films, which significantly enhances the current output (19.71 nA to 9.28 μA for one unit after acidification). Besides, the peak of C—O and O—C═O shifts slightly to the lower binding energy after HCl acidification.

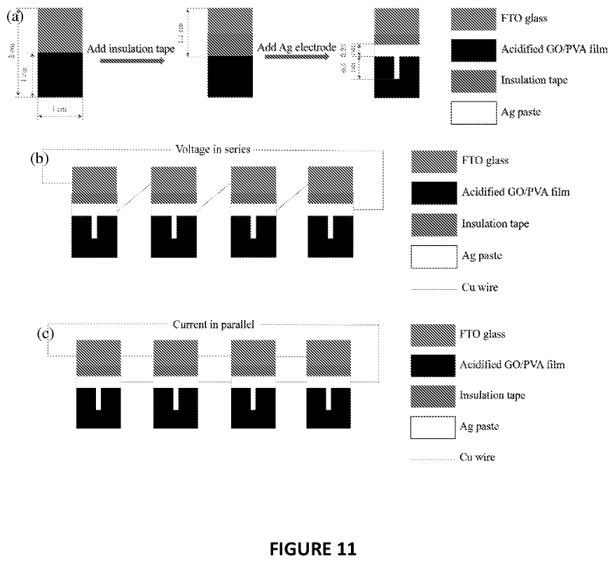

The GO/PVA MEG battery cells can be connected directly in series or in parallel to improve output of voltage or current. The schematic figures of FIGS. 11(b) and (c) show four battery cells connected in series for voltage measurements and four battery cells connected in parallel for current measurement, respectively.

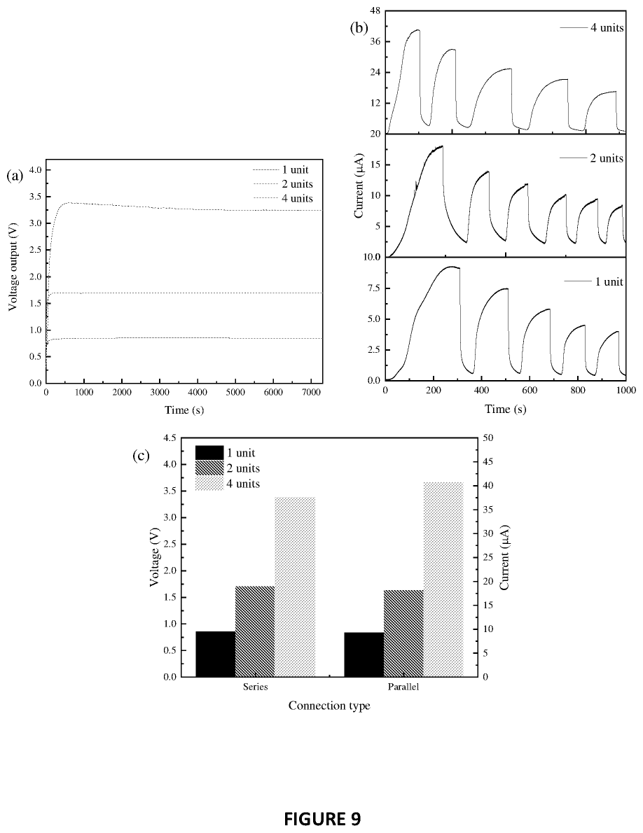

The voltage of two and four units in series show a good retention over 2 h without obvious decrease (FIG. 9a). The max voltage of units is 0.85 V, 1.70 V, 3.38 for one unit, two units, four units, respectively (FIG. 9c). The units in parallel also exhibit enhanced current output with more units involved (FIG. 9b). The max current of units is 9.28, 18.16, 40.69 for one unit, two units, four units, respectively. Thus, the voltage and current of MEG battery cells increases linearly with the output of one unit, which demonstrates a potential application in generating high electric output by simple assembly of units (battery cells).

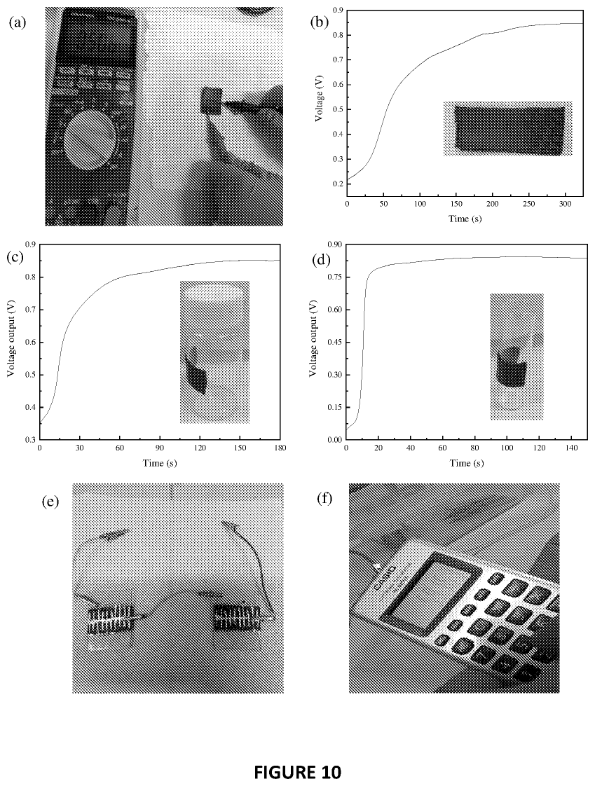

The GO/PVA films with 32% HCl acidification are also fabricated on the carbon cloth for the application of flexible device. The voltage of the film (1×1 cm²) can reach 0.506 V (FIG. 10b) in the room humidity (RH=45%).

The GO/PVA films are attached to the glass bottle with different radii to investigate the effect of film curvature on the voltage output of GO/PVA films. The voltage of films with different curvatures increases to max value in 150-300 s. The max voltage is 0.83 V, 0.85 V, 0.84 V for the films with a curvature of 0 cm⁻¹, 0.5 cm⁻¹, 1.0 cm⁻¹, respectively (FIG. 10b-10d). Thus, the voltage output of GO/PVA films with acidification on the carbon cloth shows stable voltage output on the surface with different curvature, which demonstrate a great potential in the fabrication of flexible device.

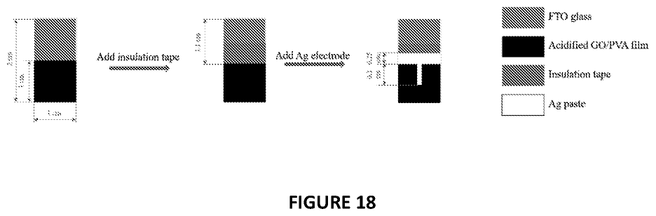

Moreover, the device array can be easily achieved by dividing the film into small pieces to supply practical devices (FIG. 10e). The acidified GO/PVA films was first fabricated on the FTO glass by the method above, followed by dividing the films into 20 cells in parallel and spread Ag paste as top electrode (FIG. 17a). The unit with 20 cells in parallel can be connected in series with other units to improve electric output (FIG. 17b). The arrays (2 in series×20 in parallel) can provide enough power to supply a calculator (FIG. 10f)

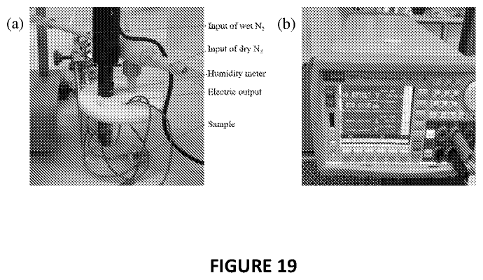

In a further example, five battery cells were connected in series to test electrical output. The example is now described below with reference to FIGS. 18 to 21.

For a single cell, a mixed solution of GO and PVA (mass ratio=1:1) was dried at 50° C. for 12 h onto the FTO glass to form a GO/PVA film (thickness≈15 μm; area≈1×1 cm²), followed by acidification of 32% HCl (soaking the films in HCl solution for 10 mins). Then it was washed with distilled water for 10 mins and dried at 50° C. for 5 h. The top Ag electrode was fabricated by spreading the Ag paste on the films (area≈0.1×0.5 cm²) and was dried at 50° C. for 10 mins (FIG. 18).

The relative humidity (RH) in the sample chamber was controlled by the input of wet N₂ and dry N₂ (FIG. 19a). The electric output was recorded in Keysight B2902A precision source/measure unit (FIG. 19b). The connection of five cells in series is illustrated in FIG. 20. For retention measurement, moisture was input by wet N₂ to increase the RH (up to 75% RH) and electric output until it reached highest value and was then stopped for retention measurement. For the measurement of a voltage/current cycle, moisture was input by wet N₂ to increase the RH and electric output until it reached highest value. The moisture was then eliminated by dry N₂ (up to 0% RH) to decrease the RH and electric output until it reached the lowest value.

A tabulation of full experiment results and data

TABLE 1
Details of experiment results and data.

| Active | | | | Output | Electric |
|---|---|---|---|---|---|
| material | Electrode | Structure | RH (%) | type | output |
| GO/PVA | Ag, FTO | Sandwiched | 75 | OC | >4.1 V after |
| | | | | | 20000 s |
| GO/PVA | Ag, FTO | Sandwiched | 75 | SC | ~58 uA (peak) |

For the humidity cycle experiment, calculations of the average time for the 5-cell in series voltage to return to 80% of its peak value when humidity level is re-introduced. The average time for 5 cells to return 80% peak value is 17.75 s.

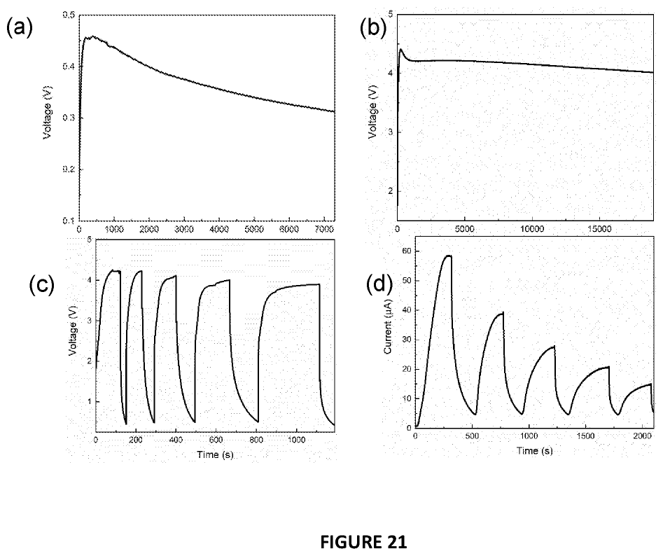

Based on FIG. 21a, a voltage discharge curve of a single MEG battery cell was produced via connected the single MEG battery cell with a resistance load of (2000 k ohms) at RH=75%. The MEG battery cell is observed to be discharging over 7000s. Voltage retention of 5 connected MEG battery cell was measured over 5.3 hours and voltage output is stable showing >4.1V after 5.3 hours in FIG. 21b. Voltage cycles and current cycles were tested on the 5 connected MEG battery cell in FIG. 21 (c&d), with voltage peak returning to over 4V and current peaking at ˜58 uA.

### CONCLUSION

We have fabricated MEG battery cell of GO/PVA films treated with HCl, which can respond to the moisture and generate electricity without any other stimuli. By adding the PVA, the GO/PVA films shows better attachment to the substrate and more stable electric output. The voltage increasing from 0.49 V to 0.85 V and current increasing from 9.28 nA to 19.71 μA after 32% HCl acidification are recorded at RH=75%, which provides a facile approach to significantly improve electric performance. The voltage can achieve a retention over 2 h without obvious decrease, which demonstrate its stable electric output for long-term application. About 4.1 V voltage or 58 μA (peak) current are easily generated by simple assembly of five MEG battery cell units in series or parallel connection, which shows a great potential in powering commercial devices. Besides, GO/PVA films are also fabricated on soft and flexible carbon cloth and generate a voltage higher than 0.8 V over 2 h, which demonstrates that it is applicable in the fabrication of flexible device.

We present an acidified film of GO and polyvinyl alcohol (PVA) for MEG battery cell. PVA with abundant hydroxyl group and good viscosity not only absorb moisture from the environment but also improves the attachment of film to the substrate, which lead to steady electric output. Besides, voltage and current output of GO/PVA film is greatly improved due to the optimisation of functional groups after acidification, which provides a facile approach to fabricate MEG with high and steady electric output. The single MEG battery cell unit can produce a high voltage of 0.85 V and a remarkable current of 9.28 μA at a relative humidity of 75%. The MEG battery cell shows a voltage retention over 2 h without obvious voltage decline. The MEG battery cell can also be connected in series and/or parallel to further improve its electric output. The voltage of five MEG battery cell in series reaches up to 4.1 V, which is high enough to power some practical electronic devices. Thus, this MEG battery cells provides a feasible approach for designing energy-harvesting from the abundant moisture in powering practical devices.

Due to the great demand for power supply, harvesting energy from the moisture is attracting growing interest in the practical application due to its abundant sources. In this paper, the electric performance of GO/PVA films is investigated, which is prepared by drop-casting followed with HCl acidification to enhance its electric output. The as-prepared GO/PVA films acidified with 32% HCl can generate an excellent voltage of 0.85 V and a high current of 9.28 μA at a relative humidity of 75%, which can get further improved by simple assembly (4.1 V or 58 μA (peak) for five units in series or parallel). The electric output is also achieved on the flexible carbon cloth, which present a facile and effective approach to generate enhanced electric performance for energy supply for flexible electronics.

The various embodiments of battery cells described above provide self-charging batteries providing large current and voltage outputs in humid environments. Such battery cells have applications in many electronic devices. In particular, the high current and voltage outputs and stable outputs of the MEG battery cells make embodiments suitable power sources for many wearable technologies which allow the battery cells to be positioned in high humidity environments, for example in contact with human skin, which has humidity of around 80% to 100%. These high humidity environments provide H+ ions to maintain charge on the battery cells. Suitable applications include health wearables, including various body sensors and electronic skin patches. The voltage and current levels generated by the MEG battery cells enable Internet of Things (IoT) devices to be powered, which may include sensors and/or wireless communication module, for example Bluetooth radio transceivers.

Section 2: Samples and Results

The Following Section 2 Describes a Second Series of Samples and Results:

An acidified GO film incorporated with a small amount of polyvinyl alcohol (PVA) for MEG application. PVA with hydroxyl group and good viscosity not only absorbs moisture from the environment but also improves the attachment of film to the substrate, which lead to stable device structure and steady electric output. Most importantly, electric output of GO/PVA film are greatly enhanced due to the optimization of functional groups and reduced film resistance after acidification, which provides a facile approach to fabricate MEG with high and steady electric output. The single unit can produce a high voltage of 0.85 V and a remarkable current of 9.28 μA (92.8 μA·cm²) at a RH of 75%, which are among the highest reported electric outputs of MEGs^{6,12}. The MEG shows a good voltage retention over 2 h without obvious decline. The MEG can also be connected in series or parallel to further improve its electric output. The voltage and current of four MEG units reach up to 3.38 V and 40.49 μA, respectively, which are high enough to power some practical electronic devices. Thus, this paper provides a feasible approach to modify functional groups in GO and produce enhanced electric outputs for powering practical electronic devices.

Methods for Samples of Section 2

Materials

Hydrochloric acid (HCl), acetic acid, sodium hydroxide (NaOH), polyvinyl alcohol (PVA) powders (Mw 13000-23000), Ag paste and silver nitrate were purchased from Sigma. GO powders were synthesized by the oxidation of graphite powders according to the Hummers method³³. 20 mg/mL GO dispersion was obtained by dispersing GO powders in distilled water with sonication for 30 min. 20 mg/mL PVA solution was obtained by dissolving PVA powders in distilled water with stirring at 90° C. for 30 min.

Fabrication of MEG

The fluorine doped tin oxide (FTO) glass was cut into 1.0×2.0 cm² pieces and was used as substrate/bottom electrode. FTO glass was then cleaned with ethanol and deionized water, followed by ultraviolet radiation for 30 min. GO dispersion and PVA solution were mixed with a mass ratio of 1:1 (maximum ratio to achieve a good attachment of GO/PVA film onto the substrate) by sonication for 30 min and was then dried directly onto the FTO glass at 50° C. for 12 h to form a 1.0×1.0 cm² GO/PVA film. The edge of GO/PVA film was covered by the insulative tape to avoid short circuit and Ag paste was printed onto the film as the top electrode. For the films fabricated on the carbon cloth (substrate/bottom electrode), the carbon cloth was soaked in the above GO/PVA dispersion for 30 min and was then dried at 50° C. for 12 h.

Chemical Treatments of MEG

As for MEG acidification, MEG was immersed in HCl solution with different concentrations for 10 min. Then MEG was washed with distilled water until no chloride ion was detected by silver nitrate solution. MEG was then dried at 50° C. for 24 h for electrical measurement and powering electronic devices. As for MEG washed with other reagents, MEG was immersed in the acetic acid or NaOH solution for 10 min and then washed with distilled water until pH=7.

Electrical Measurement

The electrodes of MEG were connected to a Keysight B2902A precision source/measure unit directly for electric output measurements. The wet N₂ and dry N₂ were used to control RH in the sample chamber. Compressed N₂ was used as dry N₂ to decrease RH in the sample chamber. Wet N₂ was obtained by flowing dry N₂ through the deionized water to increase RH in the sample chamber. For electric output retention measurement, moisture was input by wet N₂ to increase RH and electric output until electric measurement ended. For the measurement of an electric output cycle, moisture was input by wet N₂ to increase RH and electric output until it reached highest value, and then it was eliminated by dry N₂ to decrease RH and electric output. The voltage and current output of multiple units were measured by connecting the units in series and parallel, respectively.

Electric Output of MEGs

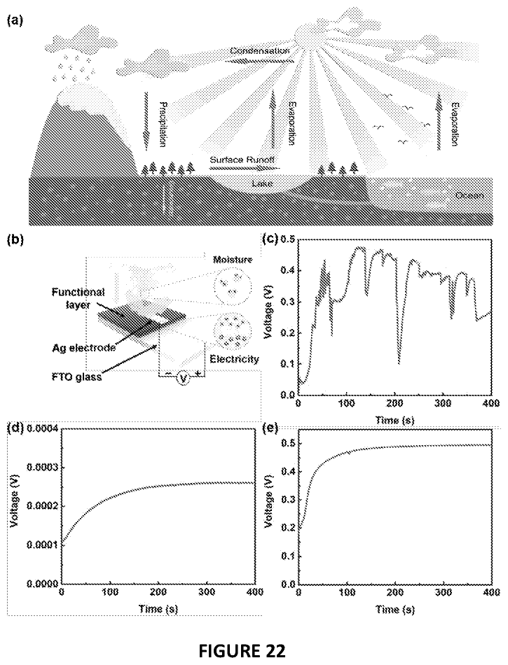

Moisture from water evaporation is an abundant and sustainable resource on the earth (FIG. 22a), which can be harvested by MEG and incorporated into self-powered system. FIG. 22b shows the schematic structure of MEG, where carbon-based materials serve as functional layer, and Ag paste and fluorine doped tin oxide (FTO) glass serve as top electrode, bottom electrode, respectively. Moisture from the environment is absorbed by the hydrophilic functional layer and facilitates charge separation between top/bottom electrode to achieve electric generation. To optimize the functional layers, three types of materials (GO, PVA and GO/PVA) were used to fabricate the devices, which were tested at RH=75%. As shown in FIG. 22c-e, the maximum voltage (Vₘₐₓ) outputs are 0.48 V for GO, 0.26 mV for PVA and 0.50 V for GO/PVA, respectively. Clearly, GO film outperforms PVA film in generating a high voltage output, but an obvious fluctuation of the voltage was observed (FIG. 22c). During the electric measurement, GO film could not be tightly attached to FTO glass due to the poor interface adhesion, which reduced the stability and reproducibility of voltage output. Differently, GO/PVA exhibited a high and stable voltage output as the PVA could act as binder to greatly improve the interface adhesion (FIG. 22e). Therefore, GO/PVA is selected as the functional layer to fabricate MEG with a high and stable electric output.

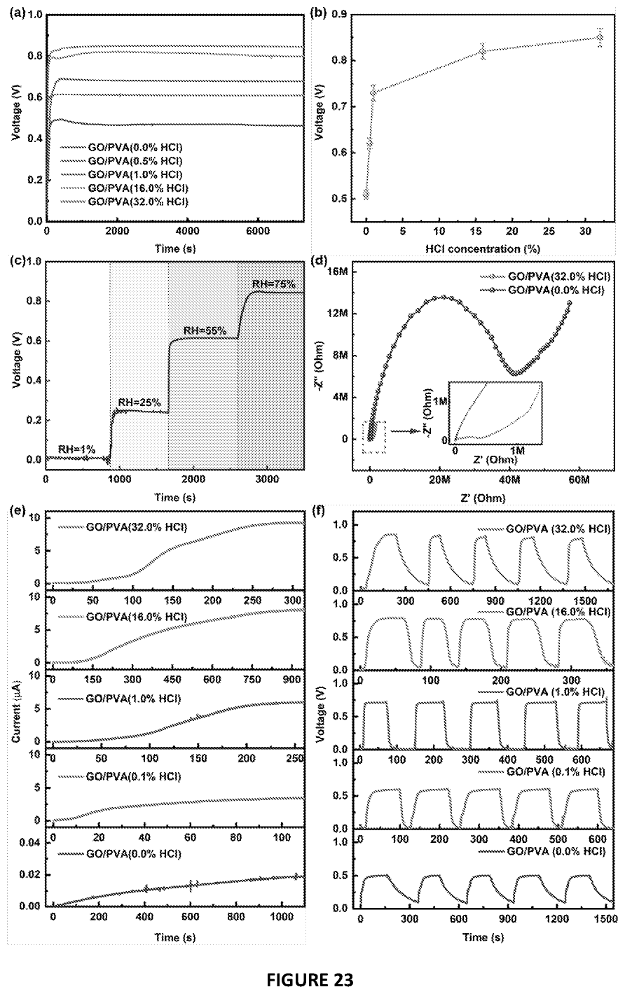

The proton concentration gradient across the functional layer is essential for the proton migration, thus dominating the voltage output. Generally, a higher concentration gradient can generate a higher voltage, which can be obtained from a higher RH and enhanced protonation ability of functional layer. Gao et al. reported that the number of surface protons increased in acidification, thus leading to improved electric output of paper-based MEG¹³. Here, we used hydrochloric acid (HCl) solution with different concentrations including 32.0%, 16.0%, 1.0%, 0.5% and 0.0% to treat GO/PVA films to tune the functional group density. As shown in FIG. 23a-b, the corresponding Vₘₐₓ of the GO/PVA films are 0.85 V, 0.82 V, 0.69V, 0.61V, and 0.50 V, respectively, which show a good retention over 2 h. Specifically, the Vₘₐₓ of 32.0% HCl treated device is 0.85 V, which is among the highest reported voltages for a single MEG. Clearly, acidification can greatly improve the voltage output because it can enhance the protonation ability, leading to a larger protonation gradient. The electric output of MEG acidified by 32.0% HCl in an external sweep voltage is investigated. The current output of MEG in positive external voltage is significantly higher than that of MEG in negative external voltage. It results from the difference of MEG resistance, which is 0.02-0.26 MΩ in positive external voltage and 0.35-2.19 MΩ in negative external voltage. It demonstrates that acidified GO/PVA films generate great protonation gradient between top and bottom surfaces. After soaking the films (acidified by 0.0% and 32.0% HCl, respectively) in 1 mL distilled water for 10 min, the pH of the water soaking different films shows same value. Thus, the dissociation of functional group, instead of ionized H⁺ from HCl solution, leads to the protonation gradient.

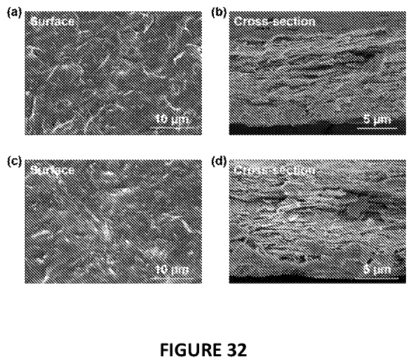

To exclude the other variants, surface morphology was characterized on the GO/PVA film with 0.0% and 32.0% HCl acidification using scanning electron microscopy (SEM). FIG. 32 shows that the morphologies of both films demonstrate no noticeable change. Meanwhile the cross-sectional SEM images exhibit that both film microstructure and thickness remain unchanged. Furthermore, the voltage output was measured on the devices with different film areas such as 0.5×0.5, 1.0×1.0 and 1.5×1.5 cm², showing that voltage remained roughly the same. In addition, the Vₘₐₓ of PVA films acidified by 32.0% HCl is 0.49 V, which is much lower than that of GO/PVA films acidified by 32.0% HCl. Thus, the acidified GO, instead of acidified PVA, contributes to the high voltage output (Vₘₐₓ=0.85 V). Therefore, these results exclude the effects of film morphology, film area and PVA on the high voltage output of the acidified GO/PVA film.

To further confirm that the proton concentration across the films induced the electric potential, different RH of 1%, 25%, 55% and 75% were performed on the top surface of the device. As shown in FIG. 23c, the corresponding Vₘₐₓ is 0.02 V, 0.22 V, 0.60 V and 0.85 V. Besides, the Vₘₐₓ of the acidified film with top/bottom and top/top electrodes at RH=75% is 0.85 V and 0.02 V, respectively. MEG with two top electrodes shows almost no voltage output due to negligible protonation gradient between two top sides of GO/PVA films. Thus, protonation gradient is closely related to the voltage output of MEG. Additionally, we investigated the effect of film thickness on the voltage output of GO/PVA films acidified by 32.0% HCl. The GO/PVA films with different thickness of 23.73 μm, 15.33 μm, 12.23 μm and 6.21 μm could produce 0.85 V, 0.85 V, 0.80 V and 0.75 V, respectively. The MEGs with thinner GO/PVA films facilitate water migration toward inner layer and lead to lower gradient of absorbed water between top and bottom sides, which reduce protonation gradient and voltage output. The above results clearly indicate that RH and functional group density in the GO/PVA device co-determine the protonation gradient and voltage output.

It is noted that RH is normally an uncontrollable condition for the MEG to produce a high voltage in practical applications. Therefore, optimizing functional group density of functional layers is particularly important to obtain desirable voltage and current output. As demonstrated in FIG. 23a, HCl treatments can tune the density of functional groups, which thereby generates various voltage output. Meanwhile, cycle stability is another key parameter determining MEG performance. The moisture was carried by the N₂ gas to the top surface of the device to produce an electric output. When the moisture was extracted by dry N2, the electric output sharply decreased. The electrochemical impedance spectroscopy (EIS) of GO/PVA with and without HCl acidification was carried out in room humidity to analyse conductivity of different MEGs (FIG. 23d). The GO/PVA with HCl acidification shows much lower resistance than GO/PVA without HCl acidification, which results from the more mobilized ions in acidified GO/PVA and is good for achieving high current output. Specifically, the maximum current output of MEG increases from 19.71 nA (197.1 nA·cm²) to 9.28 μA (92.8 μA·cm²) after 32.0% HCl acidification, which exhibits a significant improvement by acidification (FIG. 23e). FIG. 23f shows the cycling voltage output of MEG acidified with different HCl concentration. Clearly, with increasing HCl concentration, the devices produce gradually increased voltage, and demonstrate excellent cycling stability without obvious degradation in each cycle, which also exhibit a great potential in the application of humidity sensor. The electric outputs of recent reported MEGs are summarized in Table 1. Obviously, MEG with acidified GO/PVA in this work exhibits a more comprehensive electric output than the reported MEGs.

TABLE 2
Summary and comparison of MEGs

| Functional | | RH | Output | Electric | |
|---|---|---|---|---|---|
| material | Electrode | (%) | type | output | Refs. |
| Protein | Au/Au | 50 | Continuous | 0.5 V, 17 | 8 |
| | | | | μA · cm⁻² | |
| TiO₂ | Al/ITO | 85 | Transient | 0.5 V, 10 | 9 |
| | | | | μA · cm⁻² | |
| Cellulose | Au/ITO | 70 | Transient | 0.25 V, 10 | 13 |
| paper | | | | nA · cm⁻² | |
| GO/sodium | Au/Ag | 80 | Continuous | 0.6 V, >1 | 10 |
| polyacrylate | | | | μA · cm⁻² | |
| GO | Au/Au | 30 | Transient | 0.02 V, 5 | 14 |
| | | | | μA · cm⁻² | |
| Graphitic | Cu/Ag | 82 | Continuous | 0.83 V, 5.93 | 16 |
| carbon | | | | μA · cm⁻² | |
| Reduced | Au/Au | 85 | Continuous | 0.45 V, 0.9 | 17 |
| GO/GO | | | | μA · cm⁻² | |
| GO | Au/Au | 70 | Transient | 0.4 V, 2 | 18 |
| | | | | μA · cm⁻² | |
| GO/PVA | Ag/FTO | 75 | Continuous | 0.85 V, 92.8 | This |
| | | | | μA · cm⁻² | patent |

Working Mechanism

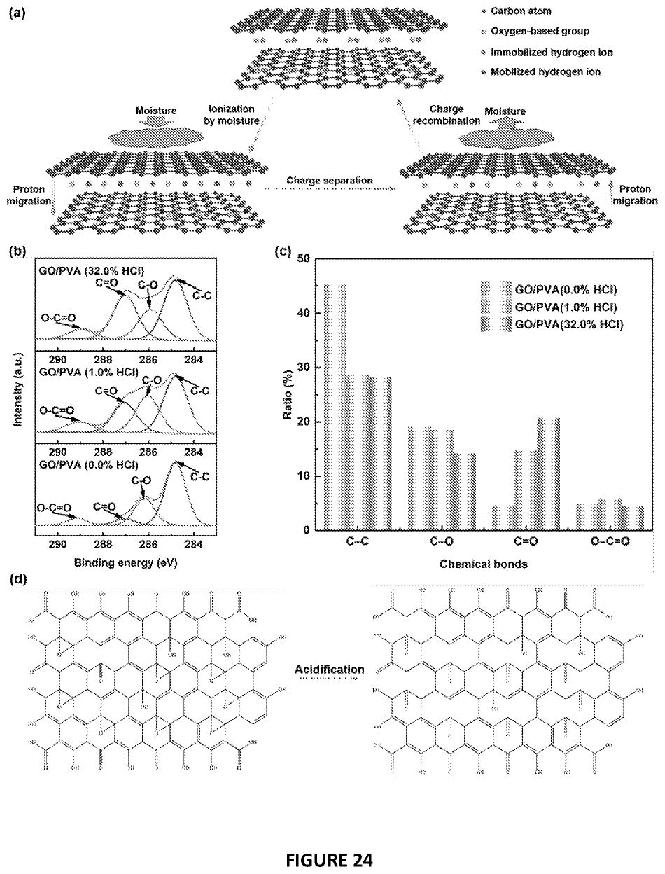

The proposed mechanism of power generation for acidified GO/PVA MEG is illustrated in FIG. 24a. which includes ionization, charge separation and charge recombination 18. The protons in the functional groups are immobilized without absorbed water from moisture. During ionization, the moisture on the top side of GO/PVA films facilitate dissociation of functional groups (—OH and —COOH), which releases mobilized H⁺ as charge carrier for electric generation^{8,10,19}. Then, H⁺ migrates from top side to the bottom side as the concentration of mobilized H⁺ is higher on the top side exposed to the moisture, which achieves charge separation and voltage generation. After moisture removal, the mobilized H⁺ migrates in the direction of water migration toward top sides and leads to charge recombination¹¹. Thus, the charge and discharge process are triggered by the moisture directly instead of complex chemical reactions so that MEG can be charged quickly and exhibits a stable electric output by harvesting this clean energy.

To verify the improved MEG device performance resulting from increased group density after HCl treatment, materials characterizations such as X-ray diffraction (XRD) and X-ray photoelectron spectroscopy (XPS) were analysed on the film with and without acidification. The diffraction peak of GO/PVA film shows a lower diffraction angle (14.4° to 6.6°) than that of GO films and shifts to a higher diffraction angle (6.6° to 8.0°) after increasing HCl concentration. The interlayer spacing of GO/PVA film can be calculated by Bragg's law^{20,21}. GO/PVA films show a higher interlayer spacing than GO films, where interlayer spacing is 0.77 nm for GO film, 1.26 nm for GO/PVA film (0.0% HCl), 1.19 nm for GO/PVA film (1.0% HCl), and 1.10 nm for GO/PVA film (32.0% HCl). The polymer molecules of PVA can enter into the GO interlayer and enlarge interlayer spacing, which may explain GO/PVA films show a higher interlayer spacing than GO films. The crosslinking between the GO and PVA bridges the adjacent GO sheets as carboxyl groups from GO can react with hydroxyl groups in the crosslinking²³, which contributes to a more uniform and stable structure. Besides, the interlayer spacing of GO/PVA films decreases after HCl acidification. The shorten spacing of GO/PVA film with HCl acidification may result from the H⁺ introduced in HCl acidification as H⁺ can be absorbed by the oxygen-based groups and inhibit the crosslinking of GO and PVA.

FIG. 24b-c show XPS spectrum of C 1s region in the GO/PVA films acidified by 0.0% HCl, 1.0% HCl and 32.0% HCl. The C 1s peaks in the GO/PVA (0.0% HCl) with binding energies of 284.8 eV, 286.2 eV, 287.0 eV, and 289.2 eV represent C—C (45.29 at. %), C—O (19.18 at. %), C═O (4.67 at. %), and O—O═O (4.84 at. %), respectively. The C 1s peaks in the GO/PVA (1.0% HCl) with binding energies of 284.8 eV, 286.0 eV, 287.0 eV, and 289.1 eV represent C—C (28.61 at. %), C—O (18.50 at. %), C═O (14.91 at. %), and O—O═O (5.96 at. %), respectively. The C 1s peaks in the GO/PVA (32% HCl) with binding energies of 284.8 eV, 285.9 eV, 287.0 eV, and 289.0 eV represent C—C (28.30 at. %), C—O (14.26 at. %), C═O (20.75 at. %), and O—O═O (4.49 at. %), respectively. Thus, the ratio of C—O bond decreases after HCl acidification, while the ratio of C═O bond increases after HCl acidification. It has been reported that the film with more C═O bonds exhibits a higher work function and surface potential²⁴. The surface potential of GO/PVA films, analysed by Kelvin probe force microscopy (KPFM) under room humidity (RH=55%), increases after acidification, which can be ascribed to the increase ratio of C═O bonds after HCl acidification.

After HCl acidification, epoxy groups can be arranged in a line, which leads to the rupture of C—C bonds^{25,26}. The epoxy chain tends to be oxidized into epoxy pairs and converted into carbonyl pairs as carbonyl groups are more stable in this condition (FIG. 24d). The C═O with stronger polarity is better than C—O in attracting H⁺ and forming hydrogen bonds²⁸. Thus, the higher voltage output can be attributed to more C═O bonds, which attract more H⁺ from the dissociation of functional groups (—OH and —COOH) and lead to greater protonation gradient for the excellent electric output. Moreover, the carrier (H⁺) density in the MEG increases after acidification due to the more dissociated H⁺ in the films exposed to the moisture, which leads to the decrease of the film resistance and increase of the current output. To confirm the exact functional groups that contributes to the improvement of voltage output, the oxygen-based groups in the GO/PVA films washed with acetic acid and NaOH are also investigated. The GO/PVA films washed with acetic acid show C—C (35.96 at. %), C—O (22.28 at. %), C═O (1.27 at. %), and O—C═O (6.13 at. %), while GO/PVA films washed with NaOH show C—C (37.86 at. %), C—O (25.24 at. %), C═O (2.74 at. %), and O—C═O (2.47 at. %). The Vₘₐₓ of GO/PVA films washed with acetic acid and NaOH is 0.34 V and 0.22 V, respectively, which are much lower than that of films acidified by HCl as the ratio of C═O in the GO/PVA films washed with acetic acid and NaOH is much lower. Thus, the ratio of C═O is closely related to the electric output of GO/PVA films.

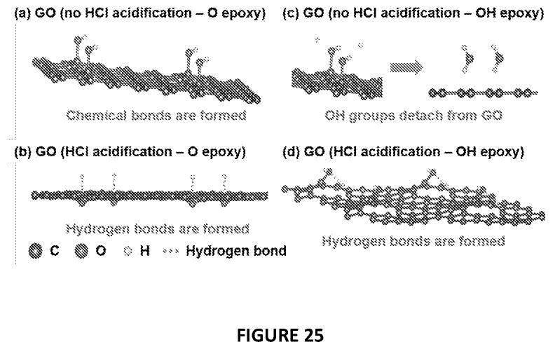

First-principles calculations based on density functional theory (DFT) were performed to provide atomistic insights into the observed enhancement effect of electric output induced by HCl acidification of graphene oxide. Specifically, we simulated proton-binding processes for O— and OH-surface functionalized graphene oxide in the presence and absence of carbon vacancies generated by the acidification. Our theoretical DFT results show that the formation of hydrogen bonds between mobile protons and surface immobilized functional groups is significantly increased by the presence of carbon vacancies, a simulation outcome that may explain the enhancement effect of electric output observed in the experiments. A summary of our theoretical DFT results is provided in FIG. 25.

In the absence of carbon vacancies (V_{C}), mobile protons tend to form strong chemical bonds with the O atoms on the carbon surface (FIG. 25a). In this case, the energy corresponding to proton binding amounts to 1.12 eV/H, which renders H chemisorption and therefore is detrimental for proton migration (i.e., the interactions between O and H turn out to be too strong). Meanwhile, the interactions between mobile protons and surface O atoms become much less intense (i.e., of the order of 0.1 eV) in the presence of V_{C} defects because the latter are already strongly adsorbed on graphene oxide. Thus, they are not prone to exchange charge with the mobile H⁺ ions (FIG. 25b). Consequently, numerous hydrogen bonds involving electrostatic attraction rather fully covalent interactions are formed on the carbon surface, which turns out to be beneficial for proton migration to achieve higher electric outputs.

In the case of considering functional group (—OH) on the carbon surface, the general conclusions are very similar to those reported in the paragraph above. It is found that —OH spontaneously detach from the carbon surface upon H binding when V c are sparse (FIG. 25c). The —OH detachment effect is driven by the formation of water molecules, which relies on charge transfers from the relatively weak C—O surface bonds (i.e., E_{O-C}≈0.1 eV) to O—H molecular bonds, and obviously is not desirable for charge-discharge cycling purposes. Conversely, in the presence of abundant carbon vacancies, the —OH that are immobilized near the V_{C} tend to establish mild hydrogen bonds with the mobile protons (FIG. 25d). In this latter case, it is energetically not favorable to transfer electrons from the very stable C—O surface bonds (i.e., E_{O-C}≈3.7 eV) to covalent O—H bonds and thus the mobile H ions are captured by the functional group (—OH) via moderate electrostatic forces.

Overall, our theoretical DFT simulations reproduce the enhancement effect of electric output induced by HCl acidification of graphene oxide observed in the experiments. The point to the increase in the formation of hydrogen bonds is the underlying cause of it.

### Demonstration of Application

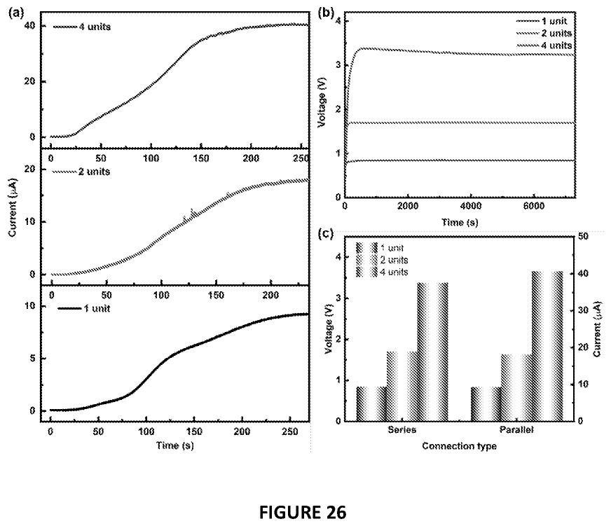

The MEGs with a high voltage and current can directly power electronic devices, such as memristor and sensors, which significantly improve their practical applications. To further enhance the voltage or current output, MEG units were connected directly in series or parallel. The maximum currents are 9.28 μA, 18.16 μA and 40.69 μA for one unit, two units and four units, respectively (FIG. 26a). In addition, the Vₘₐₓ is 0.85 V, 1.70 V and 3.38 V for one unit, two units and four units, respectively (FIG. 26b). Thus, the voltage and current of MEG increase almost linearly with the electric output of one unit (FIG. 26c), which demonstrates a great potential in generating high electric output by simple assembly of units in series or parallel. The enhanced electricity generation performance can further widen their potential applications such as hydrogen catalysis.

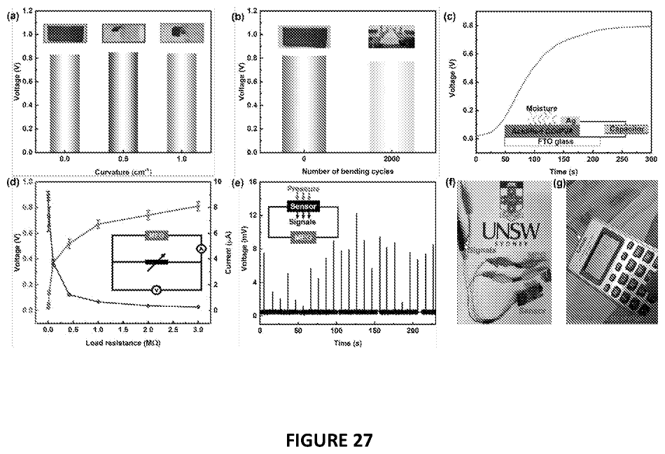

The GO/PVA films with 32.0% HCl acidification are also fabricated on the carbon cloth for flexible device applications. The acidified GO/PVA films on the carbon cloth are attached to the glass bottles with different radii to investigate the effect of film curvature on the voltage output of GO/PVA films. Vₘₐₓ is 0.83 V, 0.85 V and 0.84 V for the films with a curvature of 0.0 cm⁻¹, 0.5 cm⁻¹ and 1.0 cm⁻¹, respectively (FIG. 27a). Thus, the acidified GO/PVA films show stable voltage outputs on the flexible substrates with different curvatures, which demonstrate great potential in flexible electronics. To incorporate GO/PVA film into flexible and wearable application, the film is supposed to show a good electric output in mechanical motion such as bending. The acidified GO/PVA film on the carbon cloth was bent from 0° to 120° in one second. The flexible MEG can withstand bending deformation for 2000 times without significant Vₘₐₓ decline, which shows a great potential in flexible and wearable application (FIG. 27b).

Besides, MEG shows a good stability of charge and discharge cycles. The MEG can be charged by moisture directly and discharged at a current density of 20 μA·cm⁻². The MEG exhibits similar charge/discharge process with a good stability in each cycle. The power harvested by MEG from the moisture can also charge the power storage device directly, such as a commercial capacitor (20 μF) charged to 0.80 V in 300 s (FIG. 27c), which exhibits a great potential in energy conversion and storage at the same time. The electric output of external device powered by MEG was investigated by connecting loaded resistors with different resistances (FIG. 27d). As load increased from 1 kΩ to 3 MΩ, the voltage of resistor increased from 0.01 V to 0.81 V, whereas the current decreased from 8.55 μA to 0.27 μA. The highest output power of loaded resistor was 1.36 μW with a resistance of 0.1 MΩ. Besides, the commercial pressure sensor can be powered by a single MEG at room humidity (55%) directly and generates electric signals according to the external pressure stimulation (FIG. 27e-f and Supplementary Movie S1), which demonstrates a great potential in supplying practical device in room humidity. Moreover, the device array can be easily achieved by dividing the film into small pieces to supply practical devices as the electric output is unrelated to the film area. The acidified GO/PVA film pattern was fabricated on the FTO glass by the method above, followed by dividing the films into 20 units in parallel and coating Ag paste on the top sides of all units as the top electrodes to increase its current output. The pattern with 20 units in parallel could also be connected in series to improve the voltage output. The arrays (2 in series×20 in parallel) could provide enough power to supply a commercial calculator (FIG. 27g and Supplementary Movie S2).

### CONCLUSION

In summary, we use HCl treated GO/PVA to fabricate the MEG because HCl acidification and PVA addition can improve the protonation gradient of MEG and microstructure stability of acidified film on the substrate, respectively, which are beneficial for achieving a high electric output with a good stability. The top surface of acidified GO/PVA film is exposed to moisture directly. While the bottom side is closely sticked with FTO glass, thus robustly blocking the moisture penetration. Driven by this moisture asymmetry, the electric output is generated between top and bottom side of GO/PVA films. The GO/PVA films, as functional layer, outperform GO films and PVA films by a high and stable voltage output. The voltage output is closely related to the protonation gradient, which can get improved by HCl acidification and high RH. A high voltage of 0.85 V and an excellent current of 9.28 μA (92.8 μA·cm²) are generated at RH=75% by GO/PVA films with 32.0% HCl acidification, which can be easily enhanced by connection in series or parallel (3.38 V or 40.49 μA for four units in series or parallel). The voltage of acidified GO/PVA film on flexible carbon cloth shows no obvious decline with film curvatures and bending cycles, which demonstrates a great potential in flexible and wearable application. The acidified GO/PVA films can also be easily divided into pattern for higher electric performance and power a commercial calculator successfully, which is promising in harvesting energy from moisture and powering various practical devices.

Section 3: Samples and Results

The following Section 3 describes a third series of samples and results:

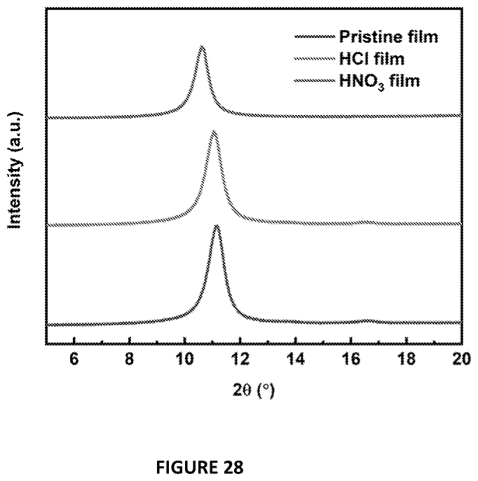

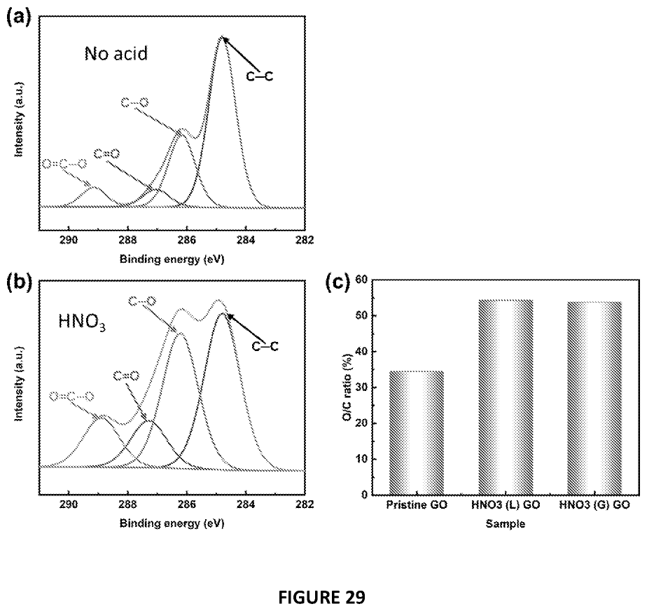

The results shown in FIGS. 28, 29, 30 and 31 relate to HNO3 treated MEG samples. The MEG samples include a functional layer comprising graphene oxide and PVA film on FTO glass. The samples were tested (a) without acidification; (b) acidified by HNO3 solution; and, (c) acidified by HNO3 vapour.

In a first method, for the liquid acid treatment, the GO/PVA layer is immersed in HNO3 solution (70 wt %) for 10 mins. Then the device is washed with distilled water for 10 mins, and dried at 50° C. for 12 h.

In a second method, for the vapour treatment, the GO/PVA layer is hanged over HNO3 solution (70 wt %) in a sealed chamber. Then the device is washed with distilled water for 10 mins, and dried at 50° C. for 12 h.

Interlayer spacing was found to increase after acidification (7.92 Å for GO, 7.99 Å for HCl GO, 8.32 Å for HNO3 GO). Higher interlayer spacing contributes to faster water migration.

The O/C ratio in pristine (non-acidified) GO film is 34.52%.

The O/C ratio in GO film acidified by HNO3 solution and HNO3 vapor is 54.31% and 53.80%, respectively. These results demonstrate that the C═O bond has been significantly increased through HNO3 treating.

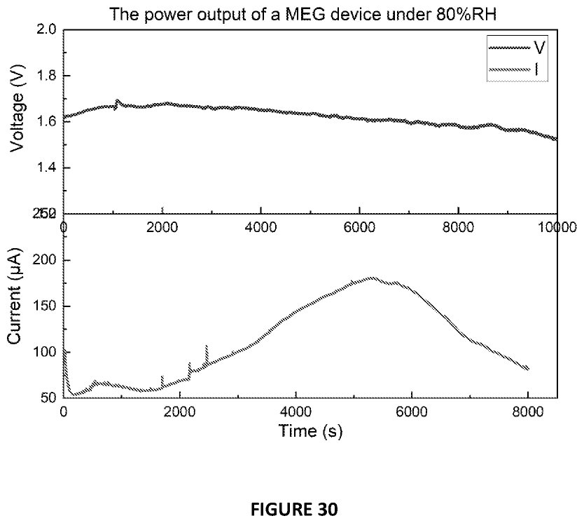

The power output of a device at 80% relative humidity is shown in FIG. 30. The sample has a zinc top electrode and carbon nano tube (CNT) bottom electrode, having an area of around 0.5 cm². The sample has an area of around 1 cm² and the functional layer is treated by 70% HNO3. The bottom electrode is MW Carbon nano tubes. For Zn foil device, it can be seen that the voltage is very high (˜1.6V), which is contributed by the redox behaviour of Zn. The current is limited the contact area of Zn with GO.

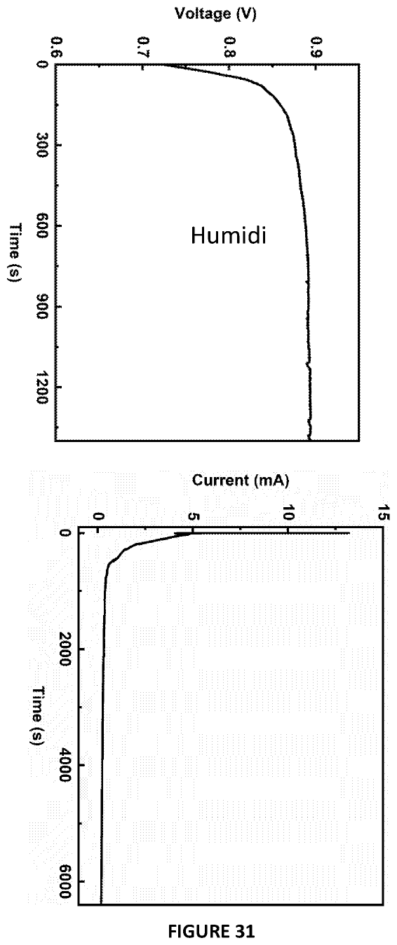

The results of FIG. 31 show the voltage/current curves at 70% humidity for a sample having a top electrode of Ag paste having an area of 0.6 cm². Vmax is 0.89 V; Imax is 13.21 mA. Current=0.19 mA after 100 min operation.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, namely, to specify the presence of the stated features but not to preclude the presence or addition of further features in various embodiments of the invention.

It is to be understood that the aforegoing description refers merely to preferred embodiments of invention, and that variations and modifications will be possible thereto without departing from the spirit and scope of the invention, the ambit of which is to be determined from the following claims.

1. A moisture electric generating battery cell comprising a function later, wherein the functional layer comprises acid treated carbon containing material.

2. A moisture electric generating battery cell according to claim 1, wherein the functional layer has a ratio of C═O bonds to C—C bonds of more than 1:9 or more than 1:8 or more than 1:7 or more than 1:6 or more than 1:5.

3. A moisture electric generating battery cell according to claim 2, wherein the ratio of C═O bonds to C—C bonds is less than 1:1.

4. A moisture electric generating battery cell according to claim 1, wherein the functional layer further comprises a polymer binder.

5. A moisture electric generating battery cell according to claim 4, wherein the polymer binder is one or more of: PVA, PVB, PMMA or PVP.

6. A moisture electric generating battery cell according to claim 4, wherein the polymer binder is in a substantially homogenous mixture with graphene oxide and the graphene oxide to polymer binder weight ratio is in the range of 100:1 to 2:1.

7. A moisture, electric generating battery cell comprising a function layer, wherein the functional layer includes acid treated graphene oxide having an interlayer spacing that is greater than the interlayer spacing of graphene oxide from which the treated graphene oxide is prepared.

8. (canceled)

9. (canceled)

10. (canceled)

11. A moisture electric generating battery cell according to claim 7, wherein the interlayer spacing of the acid treated graphene oxide is ≥0.799 nm.

12. A moisture electric generating battery cell according to claim 7, wherein the functional layer further comprises a polymer binder.

13. A moisture electric generating battery cell according to claim 12, wherein the polymer binder is one or more of: PVA, PVB, PMMA or PVP.

14. A moisture electric generating battery cell according to claim 7, wherein the interlayer spacing of the treated graphene oxide is ≥1.00 nm or is ≥1.10 nm.

15. A moisture electric generating battery cell according to claim 1, wherein in the functional layer comprises a plurality of sub-layers and at least one of the sub-layers has a first ratio of C═O bonds to C—C bonds and at least one of the other sub-layers has a second ratio of C═O bonds to C—C bonds and the first ratio is higher than the second ratio.

16. A moisture electric generating battery cell according to claim 15, wherein each sub-layer has a different ratio of C═O bonds to C—C bonds and the sub-layers are arranged to define a gradient in the ratio of C═O bonds to C—C bonds through the functional layer.

17. A moisture electric generating battery cell according to claim 1, further comprising:
first and second electrodes; and
wherein the functional layer is disposed between and is electrically connected to the first and second electrodes.

18. A moisture electric generating battery cell according to claim 17, wherein the first electrode is porous to moisture and the second electrode is insulating to moisture.

19. A moisture electric generating battery cell according to claim 17, wherein the second electrode comprises at least one of FTO, ITO, carbon nanotubes, Mxene, carbon nanoparticles, graphene; or carbon black.

20. A moisture electric generating battery cell according to claim 17, wherein the first electrode permits moisture penetration through the first electrode and into the functional layer.

21. A moisture electric generating battery cell according to claim 17, wherein the first electrode comprises silver nanowires or comprises zinc, aluminium, nickel or magnesium.

22. A moisture electric generating battery cell according to claim 17, wherein the work function of one of the first or second electrodes is higher than the work function of the functional layer and the work function of the other of the first or second electrodes is lower than the work function of the functional layer, to create a work function gradient between the first electrode, functional layer and the second electrode.

23.-36. (canceled)

37. A moisture electric generating battery cell according to claim 1,
wherein the battery cell is configured to create a moisture absorption gradient across the at least one functional layer when the moisture electric generating battery cell is exposed to moisture.

38. A moisture electric generating battery cell according to claim 17, wherein the first electrode and the second electrode comprise different electrode materials.

39. A moisture electric generating battery cell according to claim 17, wherein the first electrode and the second electrode have different moisture permeability properties.

40. (canceled)

41. (canceled)

42. A moisture electric generating battery cell according to claim 17, wherein the second electrode extends partially over the functional layer.

43. A moisture electric generating battery cell according to claim 17, wherein the first electrode has moisture insulating properties, to resist the ingress of moisture into the functional layer, and the second electrode is porous and allows moisture penetration through the second electrode and into the functional layer.

44. A moisture electric generating battery cell according to claim 1, wherein the cell is mechanically pressed to increase the moisture adsorption gradient.

45.-50. (canceled)

51. An electronic device powered by a moisture electric generating cell according to claim 1.

52. A moisture electric generating battery cell according to claim 1, wherein the carbon containing material comprises one or more of the following: carbon nano-tubes, MXene; or Carbon Nitride (C3N4).

53. A moisture electric generating battery cell according to claim 1, wherein the carbon containing material comprises graphene oxide.

54. A method of preparing a moisture electric battery cell according to claim 1, which method comprises the steps of:
(a) providing a layer comprising graphene oxide and a polymer binder; and,
(b) exposing the layer to an acid treatment.

55. A method according to claim 54, wherein the acid treatment comprises applying at least one of hydrochloric acid, nitric acid, or sulfuric acid, to the layer.

56. A method according to claim 54, wherein the acid treatment is a liquid treatment or a vapor treatment.

57. A method according to claim 54, wherein the layer further comprises a polymer binder and the layer is prepared from a mixture comprising a solution of graphene oxide mixed with a solution of the polymer binder.

58. A method according to claim 54, wherein exposing the layer to the acid treatment comprises mixing a liquid acid into a mixture used to deposit the layer.

59. A method according to claim 54, wherein the layer is prepared from a printable solution and the acid treatment involve mixing acid with the printable solution before printing the functional layer onto a substrate.

60. A method according to claim 54, wherein the method comprises applying the acid treatment after the layer is applied to a substrate.

61. A method according to claim 54, wherein acid used in the acid treatment has a concentration in the range 0.1 to 98 wt %.

62. A method according to claim 54, wherein the acid used in the acid treatment has a concentration in the range 1 to 30% to 50 wt %.

63. A method according to claim 54, wherein the method comprises preparing a plurality of mixtures, each mixture comprising graphene oxide and the polymer binder and then exposing each mixture to a different acid treatment so that each mixture has a different ratio C═O bonds to C—C bonds and then stacking the different mixtures to form the functional layer comprising a series of sub-layers and wherein the mixtures are stacked in order of the ratio of C═O bonds to C—C bonds.

64. A method according to claim 54, wherein the layer is deposited from a mixture and the step of preparing the mixture of graphene oxide and the polymer binder comprises dissolving water-soluble graphene oxide in water to form a graphene oxide solution and dissolving water-soluble polymer binder in water to form a polymer binder solution and mixing the graphene oxide solution with the polymer binder solution.

65. A method according to claim 64, wherein the graphene oxide solution and the polymer binder solution are mixed in a 1:1 mass ratio.

66. A method according to claim 64, wherein the graphene oxide solution comprises 10 to 30 mg/mL of graphene oxide.

67. A method according to claim 64, wherein the graphene oxide solution comprises 10 to 30 mg/mL of polymer binder.

68. An electronic device as claimed in claim 51, configured to have a surface positioned in contact with the skin of a subject when in use.

69. An electronic device as claimed in claim 51, configured as at least one of a sensor, a memory, or a radio transceiver.
